(19) United States
(12) Patent Application Publication
(10) Pub. No.: US 2026/0268331 A1
(43) Pub. Date: Sep. 10, 2026

(54) SYSTEMS AND METHODS FOR DIGITAL THREAT ASSESSMENT AND MITIGATION BASED ON USER IDENTITY GRAPH CONSTRUCTION

(71) Applicant: Sift Science, Inc., San Francisco, CA (US)

(72) Inventors: Volha Leusha, Mountain View, CA (US); Handong Park, Seattle, WA (US); Michael LeGore, Seattle, WA (US); Olena Pukhova, Kyiv (UA); Wei Liu, Sydney (AU); Mohammed Jouahri, New York, NY (US)

(73) Assignee: Sift Science, Inc., San Francisco, CA (US)

(21) Appl. No.: 19/562,023

(22) Filed: Mar. 10, 2026

Related U.S. Application Data
(60) Provisional application No. 63/900,277, filed on Oct. 16, 2025.
(60) Provisional application No. 63/769,335, filed on Mar. 10, 2025.

(51) Int. Cl. G06Q 20/40

(52) U.S. Cl. CPC G06Q 20/4016

(57) ABSTRACT

A system, method, and computer-program product includes obtaining a plurality of digital event records associated with a plurality of online subscriber environments; extracting, from the plurality of digital event records, user-identity-related attributes; constructing, for the plurality of subscriber environments, a global identity graph; automatically detecting indirect digital threat associations between given sets of user account node data objects within the global identity graph by executing a multi-hop traversal instruction on the global identity graph; generating, for each user account node data object in the global identity graph, a respective threat indicator based at least in part on the direct digital threat associations and detected indirect digital threat associations linked to the associated digital user account; and executing at least one workflow rule that modifies operation of a target digital user account associated with a target user account node data object based at least in part on the respective threat indicator.

### CROSS-REFERENCE TO RELATED APPLICATIONS

This application claims the benefit of U.S. Provisional Application No. 63/900,277, filed on 16-OCT-2025 and U.S. Provisional Application No. 63/769,335, filed on 10-MAR-2025, which are incorporated in their entirety by this reference.

### TECHNICAL FIELD

This invention relates generally to the field of cybersecurity, and more specifically to computer-implemented systems and methods for generating and evaluating digital identity graphs to detect, classify, and mitigate digital threats.

### BACKGROUND

In modern digital ecosystems, organizations rely heavily on online platforms to provide services such as financial transactions, e-commerce operations, data sharing, and user authentication. As these platforms scale, they generate vast amounts of event data associated with user activity, including login attempts, payment transactions, and account updates. The increasing reliance on digital platforms has led to a corresponding increase in cybersecurity threats. Fraudsters and malicious actors may exploit weaknesses in authentication processes, data validation mechanisms, and monitoring systems to perform unauthorized transactions, hijack accounts, or obscure their activities across multiple services. These threats may be further amplified by the use of sophisticated tools that enable identity obfuscation, credential stuffing, synthetic account creation, and other techniques designed to evade detection.

Conventional threat detection systems may typically rely on rule-based approaches, heuristic analysis, or other isolated tools operating within an environment of a single organization. While such approaches may provide partial protection, they often face challenges related to scalability, accuracy, and adaptability. A recurring difficulty lies in balancing false positives, which may block legitimate users, and false negatives, which may allow fraudulent activities to proceed undetected.

Furthermore, the diversity of digital signals, such as network addresses, device identifiers, and user-provided credentials, may introduce additional complexity. These signals may be inconsistent across platforms, recorded in varying formats, or incomplete due to integration differences. As a result, cybersecurity teams face ongoing challenges in processing large-scale data efficiently, ensuring data quality, and correlating signals across distributed systems.

Accordingly, there exists a need for improved systems and methods for digital threat assessment and mitigation.

The embodiments of the present application described herein provide technical solutions that address, at least the need described above.

### BRIEF SUMMARY OF THE INVENTIONS

In some embodiments, a method for identifying digital fraud or digital abuse within one or more online environments may include obtaining, from one or more distributed data sources, a plurality of digital event records associated with a plurality of online subscriber environments; extracting, from the plurality of digital event records, user-identity-related attributes; constructing, for the plurality of online subscriber environments, a global identity graph, wherein generating the global identity graph comprises: identifying, for each of the online subscriber environments, a respective plurality of digital accounts referenced within the plurality of digital event records for the online subscriber environment; constructing a plurality of user account node data objects, wherein each user account node data object of the plurality is linked to a respective digital account identifier; and constructing a plurality of edge objects representing direct digital threat associations within the plurality of user account node data objects, wherein each edge object corresponds to a match of one or more user-identity-related attributes between digital user accounts; in response to constructing the global identity graph, automatically detecting indirect digital threat associations between given sets of node data objects of the plurality of user account node data objects by executing a multi-hop traversal instruction on the global identity graph; storing the global identity graph and data associated with the direct and indirect digital threat associations in a queryable database of the digital fraud or digital abuse handling platform; receiving, via a network by the digital fraud or digital abuse handling platform, a query related to a target digital user account of the plurality of digital user accounts; using the query to access, from the queryable database, at least the data associated with digital threat associations for a target user account node data object corresponding to the target digital user account; returning, by the digital fraud or digital abuse handling platform, a digital object based at least in part on completing the query, wherein the digital object is generated based at least in part on the accessed data associated with the digital threat associations for the target user account node data object.

In some embodiments, the method may further comprise identifying a cluster of user account node data objects, wherein the cluster includes the target user account node data object and connected user account node data objects with which the target user account node data object has direct digital threat associations or indirect digital threat associations; aggregating historical behavioral information associated with the target user account node data object and the connected user account node data objects to generate a threat profile for the target user account node data object; and generating the digital object based at least in part on the threat profile.

In some embodiments, the interface of the digital fraud or digital abuse handling platform comprises a graphical user interface; and the digital object comprises a visualization artifact configured to display information associated with the generated threat profile when provided to the graphical user interface.

In some embodiments, the visualization artifact is generated while withholding one or more underlying user-identity-related attributes used to construct the global identity graph, thereby enabling the information within the generated threat profile to be displayed at the graphical user interface without exposing the one or more underlying user-identity-related attributes.

In some embodiments, the visualization artifact comprises: a list of connected user account node visualization objects, wherein each entry within the list comprises: an index corresponding to a respective connected user account node data object of the cluster, an attribute-combination pattern used to identify the match between the target user account node data object and the respective connected user account node data object, and one or more usage or transaction metrics associated with the respective connected user account node data object, wherein: the connected user account node visualization objects within the list are grouped according to subscriber-environment classifications associated with the respective connected user account node data objects.

In some embodiments, the visualization artifact comprises: a summary object indicating aggregated behavioral information associated with the connected user account node data objects within the cluster over a defined historical period.

In some embodiments, the method further comprises deriving a respective geographic region identifier for each of the connected user account node data objects that have direct digital threat associations or indirect digital threat associations with the target user account node data object; adding, to the visualization artifact, a geographic visualization object that includes the geographic region identifiers while withholding one or more underlying user-identity-related attributes used to construct the global identity graph, thereby enabling the geographic visualization object to display the geographic identifiers at the graphical user interface without exposing the one or more underlying user-identity-related attributes.

In some embodiments, the method further comprises detecting, based at least in part on the threat profile, that the cluster corresponds to a fraud ring or an abuse ring; adding, to the visualization artifact, an alert or visual indication indicative of coordinated fraud or abuse activity based at least in part on detecting that the cluster corresponds to a fraud ring or abuse ring.

In some embodiments, the visualization artifact comprises: a target user account node visualization object corresponding to the target user account node data object; one or more connected user account node visualization objects, wherein each connected user account node visualization object corresponds to a respective connected user account data object that has a direct digital threat association or indirect digital threat association with the target user account node data object; and one or more edge visualization objects, wherein each edge visualization object corresponds to a respective edge object linking the target user account node data object to a respective connected user account data object.

In some embodiments, the visualization artifact comprises: one or more selectable control elements that, when selected via user input, initiates execution of at least one workflow rule at the digital fraud or digital abuse handling platform, thereby modifying an operation of the target digital user account.

In some embodiments, the method further comprises generating, for each user account node data object within the global identity graph, a respective threat profile, wherein: storing the data associated with the direct and indirect digital threat associations comprises storing the respective threat profile for each user account node data object within the queryable database, and accessing the data associated with digital threat associations for the target user account node data object comprises accessing the threat profile for the target user account node data object from the queryable database.

In some embodiments, the method further comprises generating the threat profile for the target user account node data object based at least in part on the data accessed from the queryable database using the query associated with the digital threat associations for the target user account node data object.

In some embodiments, the query includes one or more user-identity-related attribute values of the target digital user account, the method further comprising: locating the target user account node data object within the global identity graph linked to the target digital user account based at least in part on the one or more user-identity-related attributes values included within the query; and encoding, within the digital object prior to the outputting, identity information of the target user account node data objects and one or more connected user node data objects with which the target user account node data object has direct digital threat associations or indirect digital threat associations.

In some embodiments, constructing an edge object of the plurality of edge objects comprises: applying, to the extracted user-identity-related attributes, one or more configurable matching rules to determine that a match of the one or more user-identity-related attributes has occurred, wherein applying the one or more configurable matching rules comprises: determining that the one or more user-identity-related attributes satisfy an attribute-combination pattern defined by the one or more configurable matching rules; generating a confidence score based on one or more discriminative weights, each of the one or more discriminative weights corresponding to a respective attribute type of the one or more user-identity-related attributes; and assigning the one or more user-identity-related attributes and the confidence score to the edge object.

In some embodiments, the method further comprises generating, for each user account node data object in the global identity graph, a respective threat indicator based at least in part on the direct digital threat associations and detected indirect digital threat associations linked to the associated digital user account; determining that the target user account node data object has a quantity of associations with high-threat user account node data objects that exceeds a predefined association quantity threshold, wherein each of the high-threat user account node data objects have a threat indicator exceeding a predefined threat threshold; adjusting the threat indicator to indicate a higher threat likelihood based at least in part on the quantity of digital threat associations with high-threat user account node data objects exceeding the predefined association quantity threshold.

In some embodiments, the method further comprises predicting, based on the adjusted threat indicator, whether the target digital user account satisfies at least one of: a fraudulent activity condition associated with the target user account node data object; an abuse activity condition associated with the target user account node data object; or a predicted adverse authorization outcome associated with the target user account node data object.

In some embodiments, a method for mitigating digital fraud or digital abuse within one or more online environments comprises obtaining, from one or more distributed data sources, a plurality of digital event records associated with a plurality of online subscriber environments; extracting, from the plurality of digital event records, user-identity-related attributes; constructing, for the plurality of online subscriber environments, a global identity graph, wherein generating the global identity graph comprises: identifying, for each of the online subscriber environments, a respective plurality of digital accounts referenced within the plurality of digital event records for the online subscriber environment; constructing a plurality of user account node data objects, wherein each user account node data object of the plurality is linked to a respective digital account identifier; and constructing a plurality of edge objects representing direct digital threat associations within the plurality of user account node data objects, wherein each edge object corresponds to a match of one or more user-identity-related attributes between digital user accounts; in response to constructing the global identity graph, automatically detecting indirect digital threat associations between given sets of node data objects of the plurality of user account node data objects by executing a multi-hop traversal instruction on the global identity graph; generating, for each user account node data object in the global identity graph, a respective threat indicator based at least in part on the direct digital threat associations and detected indirect digital threat associations linked to the associated digital user account; and executing at least one workflow rule that modifies operation of a target digital user account associated with a target user account node data object, wherein the at least one workflow rule is executed based at least in part on the respective threat indicator and the respective digital threat associations corresponding to the target user account node data object.

In some embodiments, the method further comprises determining that the target user account node data object linked to the target digital user account has a quantity of digital threat associations with high-threat user account node data objects that exceeds a predefined association quantity threshold, wherein each of the high-threat user account node data objects have a threat indicator exceeding a predefined threat threshold, wherein: executing the at least one workflow rule is based at least on the quantity of digital threat associations exceeding the predefined association quantity threshold; and executing the at least one workflow rule comprises: placing the target digital user account into a limited-functionality mode requiring one or more additional authentication factors; blocking or placing a hold on one or more transactions associated with the target digital user account; or routing the target digital user account to a fraud analyst interface for manual review.

In some embodiments, the method further comprises determining that the target digital user account associated has an age below a predefined threshold; and determining that the target user account node data object linked to the target digital user account has a quantity of digital threat associations with low-threat user account node data objects that exceeds a predefined association quantity threshold, wherein each of the low-threat user account node data objects have a threat indicator below a predefined threat threshold, wherein: executing the at least one workflow rule is based at least on the quantity of digital threat associations exceeding the predefined association quantity threshold when the age of the digital user account is below the age threshold; and executing the at least one workflow rule comprises: placing the target digital user account into a full-functionality mode with a same number of authentication factors as the low-threat digital user accounts; or allowing one or more transactions associated with the target digital user account.

In some embodiments, a computer-implemented system may comprise processing circuitry; a memory; and a computer-readable medium operably coupled to the processing circuitry the computer-readable medium having computer-readable instructions stored thereon that, when executed by the processing circuitry, cause a computing device to perform operations comprising: obtaining, from one or more distributed data sources, a plurality of digital event records associated with a plurality of online subscriber environments; extracting, from the plurality of digital event records, user-identity-related attributes; constructing, for the plurality of online subscriber environments, a global identity graph, wherein generating the global identity graph comprises: identifying, for each of the online subscriber environments, a respective plurality of digital accounts referenced within the plurality of digital event records for the online subscriber environment; constructing a plurality of user account node data objects, wherein each user account node data object of the plurality is linked to a respective digital account identifier; and constructing a plurality of edge objects representing direct digital threat associations within the plurality of user account node data objects, wherein each edge object corresponds to a match of one or more user-identity-related attributes between digital user accounts; in response to constructing the global identity graph, automatically detecting indirect digital threat associations between given sets of node data objects of the plurality of user account node data objects by executing a multi-hop traversal instruction on the global identity graph; storing the global identity graph and data associated with the direct and indirect digital threat associations in a queryable database of the digital fraud or digital abuse handling platform; receiving, via a network by the digital fraud or digital abuse handling platform, a query related to a target digital user account of the plurality of digital user accounts; using the query to access, from the queryable database, at least the data associated with digital threat associations for a target user account node data object corresponding to the target digital user account; returning, by the digital fraud or digital abuse handling platform, a digital object based at least in part on completing the query, wherein the digital object is generated based at least in part on the accessed data associated with the digital threat associations for the target user account node data object.

In some embodiments, a method for identifying digital fraud or digital abuse within one or more online environments comprises: obtaining, from one or more distributed data sources, a plurality of digital event records associated with a plurality of online subscriber environments; extracting, from the plurality of digital event records, user-identity-related attributes; constructing, for the plurality of online subscriber environments, a global identity graph, wherein generating the global identity graph comprises: identifying, for each of the online subscriber environments, a respective plurality of digital accounts referenced within the plurality of digital event records for the online subscriber environment; constructing a plurality of user account node data objects, wherein each user account node data object of the plurality is linked to a respective digital account identifier; and constructing a plurality of edge objects representing direct digital threat associations within the plurality of user account node data objects, wherein each edge object corresponds to a match of one or more user-identity-related attributes between digital user accounts; in response to constructing the global identity graph, automatically detecting indirect digital threat associations between given sets of node data objects of the plurality of user account node data objects by executing a multi-hop traversal instruction on the global identity graph; storing the global identity graph and data associated with the digital threat associations in a queryable database of the digital fraud or digital abuse handling platform; receiving, via a network by the digital fraud or digital abuse handling platform, a query related to a target digital user account of the plurality of digital user accounts; using the query to access from the queryable database at least the data associated with the digital threat associations based on detecting the target digital user account as being a node of the global identity graph; and returning, by the digital fraud or digital abuse platform, a digital object based at least in part on completing the query, wherein the digital object is generated based at least in part on identifying direct digital threat associations or indirect digital threat associations of the target digital user account to one or more user node data objects of the global identity graph.

### BRIEF DESCRIPTION OF THE FIGURES

FIG. 1 illustrates a schematic representation of a system 100 in accordance with one or more embodiments of the present application;

FIG. 2 illustrates an example method 200 in accordance with one or more embodiments of the present application;

FIG. 3 illustrates an example process for digital threat assessment and mitigation based on user identity graph construction, in accordance with one or more embodiments of the present application;

FIG. 4 illustrates a normalization process for normalizing user identity-related fields into standardized attributes, in accordance with one or more embodiments of the present application;

FIG. 5 illustrates an example architecture 500 for constructing internal identity graphs within a subscriber environment, in accordance with one or more embodiments of the present application.

FIG. 6 illustrates an example architecture for generating a global identity graph from multiple distinct subscriber environments, in accordance with one or more embodiments of the present application;

FIG. 7 illustrates an example of cross-user associations, in accordance with one or more embodiments of the present application;

FIG. 8 illustrates an example of execution of a multi-hop traversal instruction on a global identity graph, in accordance with one or more embodiments of the present application;

FIG. 9 illustrates an example of connection type outcomes for user accounts, in accordance with one or more embodiments of the present application;

FIG. 10 illustrates an example of a graphical user interface in accordance with one or more embodiments of the present application;

FIG. 11 illustrates an example interactive user account listing view in accordance with one or more embodiments of the present application;

FIG. 12 illustrates an example expandable menu view in accordance with one or more embodiments of the present application; and

FIG. 13 illustrates an example configurable matching rule table in accordance with one or more embodiments of the present application.

### DESCRIPTION OF THE PREFERRED EMBODIMENTS

The following description of the preferred embodiments of the inventions are not intended to limit the inventions to these preferred embodiments, but rather to enable any person skilled in the art to make and use these inventions.

### 1. System for Digital Fraud and/or Abuse Detection and Scoring

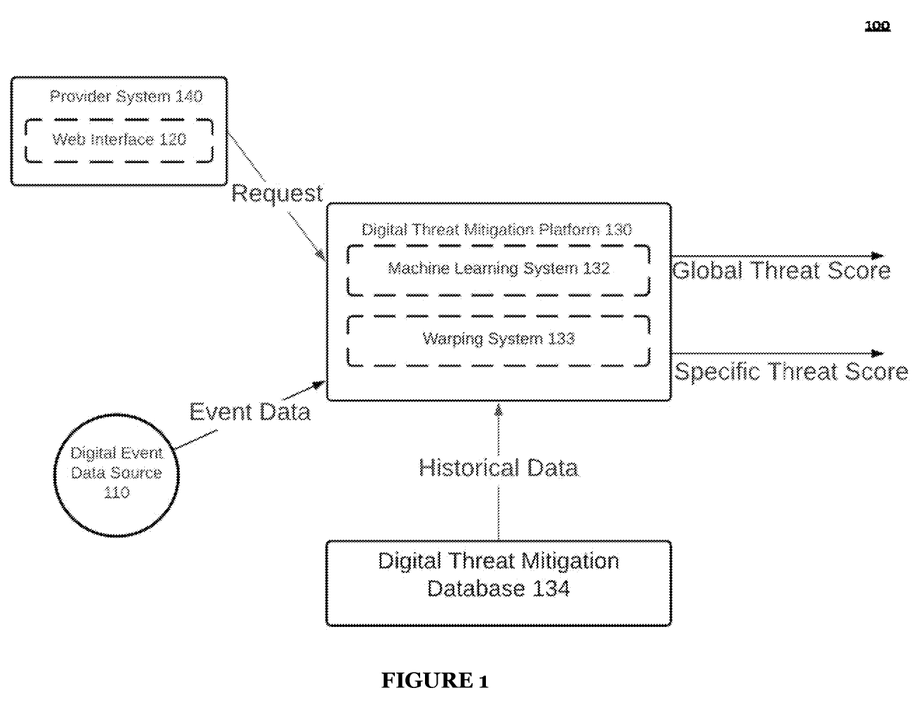

As shown in FIG. 1, a system 100 for detecting digital fraud and/or digital abuse includes one or more digital event data sources 110, a web interface 120, a digital threat mitigation platform 130, and a service provider system 140.

The system 100 functions to enable a prediction of multiple types of digital abuse and/or digital fraud within a single stream of digital event data. The system 100 provides web interface 120 that enables subscribers to and/or customers of a threat mitigation service implementing the system 100 to generate a request for a global digital threat score and additionally, make a request for specific digital threat scores for varying digital abuse types. After or contemporaneously with receiving a request from the web interface 120, the system 100 may function to collect digital event data from the one or more digital event data sources 110. The system 100 using the digital threat mitigation platform 130 functions to generate a global digital threat score and one or more specific digital threat scores for one or more digital abuse types that may exist in the collected digital event data.

The one or more digital event data sources 110 function as sources of digital events data and digital activities data, occurring fully or in part over the Internet, the web, mobile applications, and the like. The one or more digital event data sources 110 may include a plurality of web servers and/or one or more data repositories associated with a plurality of service providers. Accordingly, the one or more digital event data sources 110 may also include the service provider system 140.

The one or more digital event data sources 110 function to capture and/or record any digital activities and/or digital events occurring over the Internet, web, mobile applications (or other digital/Internet platforms) involving the web servers of the service providers and/or other digital resources (e.g., web pages, web transaction platforms, Internet-accessible data sources, web applications, etc.) of the service providers. The digital events data and digital activities data collected by the one or more digital event data sources 110 may function as input data sources for a machine learning system 132 of the digital threat mitigation platform 130.

The digital threat mitigation platform 130 functions as an engine that implements at least a machine learning system 132 and, in some embodiments, together with a warping system 133 to generate a global threat score and one or more specific digital threat scores for one or more digital abuse types. The digital threat mitigation platform 130 functions to interact with the web interface 120 to receive instructions and/or a digital request for predicting likelihoods of digital fraud and/or digital abuse within a provided dataset. The digital threat mitigation engine 130 may be implemented via one or more specifically configured web or private computing servers (or a distributed computing system) or any suitable system for implementing system 100 and/or method 200.

The machine learning system 132 functions to identify or classify features of the collected digital events data and digital activity data received from the one or more digital event data sources 110. The machine learning system 132 may be implemented by a plurality of computing servers (e.g., a combination of web servers and private servers) that implement one or more ensembles of machine learning models. The ensemble of machine learning models may include hundreds and/or thousands of machine learning models that work together to classify features of digital events data and namely, to classify or detect features that may indicate a possibility of fraud and/or abuse. The machine learning system 132 may additionally utilize the input from the one or more digital event data sources 110 and various other data sources (e.g., outputs of system 100, system 100 derived knowledge data, external entity-maintained data, etc.) to continuously improve or accurately tune weightings associated with features of the one or more of the machine learning models defining the ensembles.

The warping system 133 of the digital threat mitigation platform 130, in some embodiments, functions to warp a global digital threat score generated by a primary machine learning ensemble to generate one or more specific digital threat scores for one or more of the plurality of digital abuse types. In some embodiments, the warping system 133 may function to warp the primary machine learning ensemble, itself, to produce a secondary (or derivative) machine learning ensemble that functions to generate specific digital threat scores for the digital abuse and/or digital fraud types. Additionally, or alternatively, the warping system 130 may function to implement a companion machine learning model or a machine learning model that is assistive in determining whether a specific digital threat score should be generated for a subject digital events dataset being evaluated at the primary machine learning model. Additionally, or alternatively, the warping system 133 may function to implement a plurality of secondary machine learning models defining a second ensemble that may be used to selectively determine or generate specific digital threat scores. Accordingly, the warping system 133 may be implemented in various manners including in various combinations of the embodiments described above.

The digital threat mitigation database 134 includes one or more data repositories that function to store historical digital event data. The digital threat mitigation database 134 may be in operable communication with one or both of an events API and the machine learning system 132. For instance, the machine learning system 132 when generating global digital threat scores and specific digital threat scores for one or more specific digital abuse types may pull additional data from the digital threat mitigation database 134 that may be assistive in generating the digital threat scores.

The ensembles of machine learning models may employ any suitable machine learning including one or more of: supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), adversarial learning, and any other suitable learning style. Each module of the plurality can implement any one or more of: a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminate analysis, etc.), a clustering method (e.g., k-means clustering, density-based spatial clustering of applications with noise (DBSCAN), expectation maximization, etc.), a bidirectional encoder representation form transformers (BERT) for masked language model tasks and next sentence prediction tasks and the like, variations of BERT (i.e., ULMFiT, XLM UDify, MT-DNN, SpanBERT, RoBERTa, XLNet, ERNIE, KnowBERT, VideoBERT, ERNIE BERT-wwm, GPT, GPT-2, GPT-3, ELMo, content2Vec, and the like), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial lest squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and any suitable form of machine learning algorithm. Each processing portion of the system 100 can additionally or alternatively leverage: a probabilistic module, heuristic module, deterministic module, or any other suitable module leveraging any other suitable computation method, machine learning method or combination thereof. However, any suitable machine learning approach can otherwise be incorporated in the system 100. Further, any suitable model (e.g., machine learning, non-machine learning, etc.) may be implemented in the various systems and/or methods described herein.

The service provider 140 functions to provide digital events data to the one or more digital event data processing components of the system 100. Preferably, the service provider 140 provides digital events data to an events application program interface (API) associated with the digital threat mitigation platform 130. The service provider 140 may be any entity or organization having a digital or online presence that enables users of the digital resources associated with the online presence of the service provider 140 to perform transactions, exchanges of data, perform one or more digital activities, and the like.

The service provider 140 may include one or more web or private computing servers and/or web or private computing devices. Preferably, the service provider 140 includes one or more client devices functioning to operate the web interface 120 to interact with and/or communicate with the digital threat mitigation engine 130.

The web interface 120 functions to enable a client system or client device to operably interact with the remote digital threat mitigation platform 130 of the present application. The web interface 120 may include any suitable graphical frontend that can be accessed via a web browser using a computing device. The web interface 120 may function to provide an interface to provide requests to be used as inputs into the digital threat mitigation platform 130 for generating global digital threat scores and additionally, specific digital threat scores for one or more digital abuse types. Additionally, or alternatively, the web (client) interface 120 may be used to collect manual decisions with respect to a digital event processing decision, such as hold, deny, accept, additional review, and/or the like. In some embodiments, the web interface 120 includes an application program interface that is in operable communication with one or more of the computing servers or computing components of the digital threat mitigation platform 130.

The web interface 120 may be used by an entity or service provider to make any suitable request including requests to generate global digital threat scores and specific digital threat scores. In some embodiments, the web interface 120 comprises an application programming interface (API) client and/or a client browser.

Additionally, the systems and methods described herein may implement the digital threat mitigation platform in accordance with the one or more embodiments described in the present application as well as in the one or more embodiments described in U.S. Patent Application No. 15/653,373, which is incorporated by reference in its entirety.

### 2. Method for Automated Construction and Evaluation of Digital Identity Graphs for Threat Mitigation

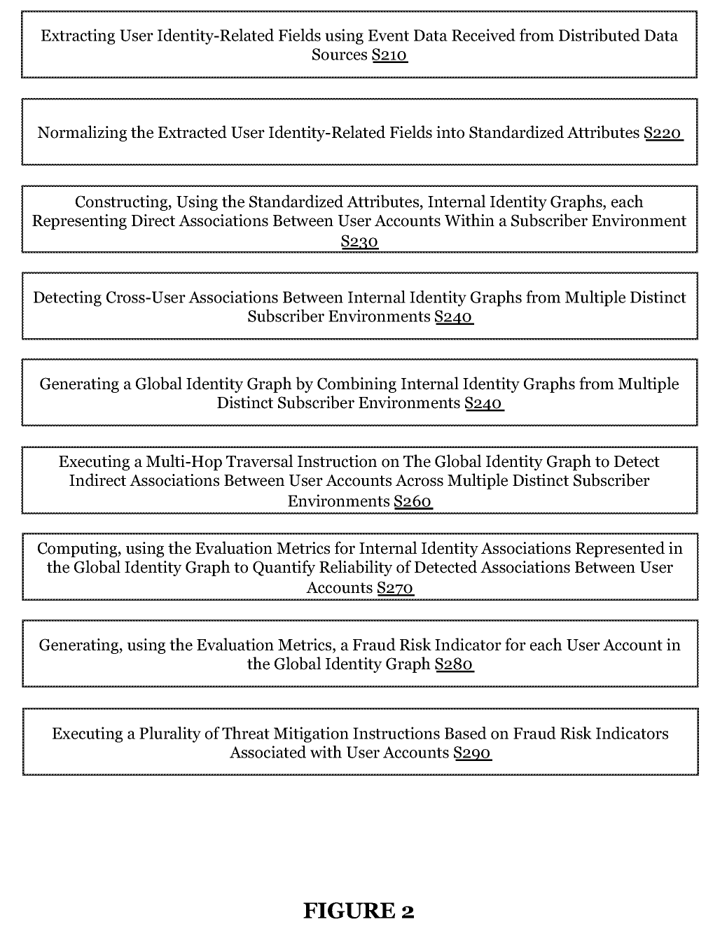

As shown in FIG. 2, the method 200 for automated construction and evaluation of digital identity graphs for threat mitigation may include extracting user identity-related fields from raw digital event records received from distributed data sources S210, normalizing the extracted user identity-related fields into standardized attributes S220, constructing, using the standardized attributes, internal identity graphs, each representing direct associations between user accounts within a subscriber environment S230, detecting cross-user associations between internal identity graphs from multiple distinct subscriber environments S240, generating a global identity graph by linking user accounts across multiple distinct subscriber environments using standardized attributes S250,executing a multi-hop traversal instruction on the global identity graph to detect indirect associations between user accounts across multiple distinct subscriber environments S260, computing evaluation metrics for internal identity associations represented in the updated global identity graph to quantify reliability of detected associations between user accounts S270, generating, using the evaluation metrics, a fraud risk indicator for each user account in the global identity graph S280, and executing a plurality of threat mitigation instructions based on fraud risk indicators associated with user accounts S290.

In many digital service ecosystems, user activity data is generated across multiple independent computing environments operated by different subscriber systems. Each subscriber environment may maintain separate user account records and may collect heterogeneous event data describing user interactions within the environment. As a result, digital identities corresponding to a single underlying user may become fragmented across multiple computing systems, each storing incomplete or partially overlapping identity information. Conventional fraud-detection systems that operate within a single subscriber environment may therefore fail to detect coordinated abuse activity spanning multiple systems because the relevant identity evidence is distributed across disparate datasets and incompatible event schemas. The digital threat mitigation platform 130 addresses this technical challenge by implementing a graph-based identity resolution architecture that programmatically aggregates identity attributes extracted from distributed event records and constructs a unified identity graph representing relationships among digital user accounts across subscriber environments. By transforming fragmented event data into a structured graph representation, the digital threat mitigation platform 130 enables automated analysis of identity relationships that would otherwise remain computationally infeasible using conventional isolated account analysis techniques.

In practical implementations, the global identity graph generated by the digital threat mitigation platform 130 may contain millions of user-account node records and tens of millions of edge data objects representing identity associations derived from event data originating from multiple subscriber environments. Execution of traversal operations across such large-scale graph structures presents significant computational challenges, including memory management, traversal-state tracking, and avoidance of exponential path expansion during multi-hop analysis. The multi-hop traversal module therefore employs constrained traversal instructions that may include depth limits, attribute-based filtering rules, and confidence-score thresholds in order to reduce computational complexity while preserving meaningful identity-link evidence. By implementing graph traversal logic within a dedicated processing module capable of operating on large-scale identity graphs stored in memory-resident or graph-database data structures, the digital threat mitigation platform 130 enables efficient discovery of indirect associations across distributed identity datasets while maintaining scalable performance within production computing environments.

### 2.10 Extracting User Identity-Related Fields using Event Data Received from Distributed Data Sources

S210, which includes extracting user identity-related fields using event data received from distributed data sources, may function to extract information relevant to digital identity corresponding to one or more user accounts from heterogeneous event data. In the context of the present disclosure, event data may refer to records generated by computer-implemented systems in response to operations of a user account within a subscriber environment. A user account may refer to a logical identity maintained by a subscriber environment that associates one or more digital resources with a particular user, including but not limiting to, credentials, preferences, and stored information. A subscriber environment may refer to a customer-operated system integrated with the digital threat mitigation platform 130, such as an e-commerce environment, a financial services environment, or a social networking environment, and/or the like, each generating event data in connection with the operation of user accounts.

In one implementation, event data may include explicitly provided information (e.g., email address, phone number, billing address, or shipping address) as well as system-captured telemetry (e.g., Internet Protocol (IP) address, device identifier, browser fingerprint, or Transport Layer Security (TLS) client fingerprint). Accordingly, S210 may function to identify and extract user identity-related fields from event data so as to generate structured identity information suitable for further processing by the digital threat mitigation platform 130.

In an embodiment, distributed data sources may include multiple distinct systems from which event data associated with the operation of one or more user accounts may be obtained. For example, the distributed data sources may include computing systems, application servers, or databases configured to log transactions within a subscriber environment. The distributed data sources may generate event data corresponding to account logins, payment authorizations, account creation requests, data retrieval operations, or other application-layer transactions executed by user accounts. In one non-limiting example, the distributed data sources may include digital event data source 110, as shown in FIG. 1. The digital event data source 110 may function as a source of event data and digital activity data occurring across web applications, mobile applications, or other Internet-connected platforms maintained by a subscriber environment. In general, the distributed data sources may be heterogeneous in architecture and geographic location and may collectively supply the digital threat mitigation platform 130 with event data required for extraction of user identity-related fields.

In one example, a distributed data source may be implemented as a web server cluster within an e-commerce subscriber environment. The digital event data source 110 may generate event data when a user account initiates an online purchase, updates stored payment credentials, or modifies delivery preferences through a web application of the e-commerce subscriber environment. The event data generated by the distributed data source may be recorded by log management software and database systems as structured or semi-structured transaction records comprising Hypertext Transfer Protocol (HTTP) headers, secure form payloads, application log entries, and/or contextual metadata. The event data generated by the distributed data source may at least include information relevant to user identity such as, but not limited to, a billing address, a shipping address, a phone number, and an Internet Protocol (IP) address associated with one or more originating requests. The user identity-related fields extracted from the event data in this example may therefore include the billing address, the shipping address, the phone number, and the IP address.

In another example, the distributed data source may be implemented as a mobile application server within a financial services subscriber environment. The distributed data source may generate event data responsive to a user account executing a mobile login, initiating a funds transfer, and/or configuring multi-factor authentication through a mobile application of the financial services subscriber environment. The event data generated by the digital event data source 110 may be logged by session management software as session records comprising device telemetry, cryptographic handshake parameters, and/or application request metadata. The event data generated by the distributed data source may at least include information relevant to user identity such as, but not limited to, an email address, a phone number used for SMS verification, a device identifier corresponding to the mobile device, and a Transport Layer Security (TLS) client fingerprint such as a JA3 or JA4 signature. The user identity-related fields extracted from the event data in this example may therefore include the email address, the phone number, the device identifier, and the TLS client fingerprint.

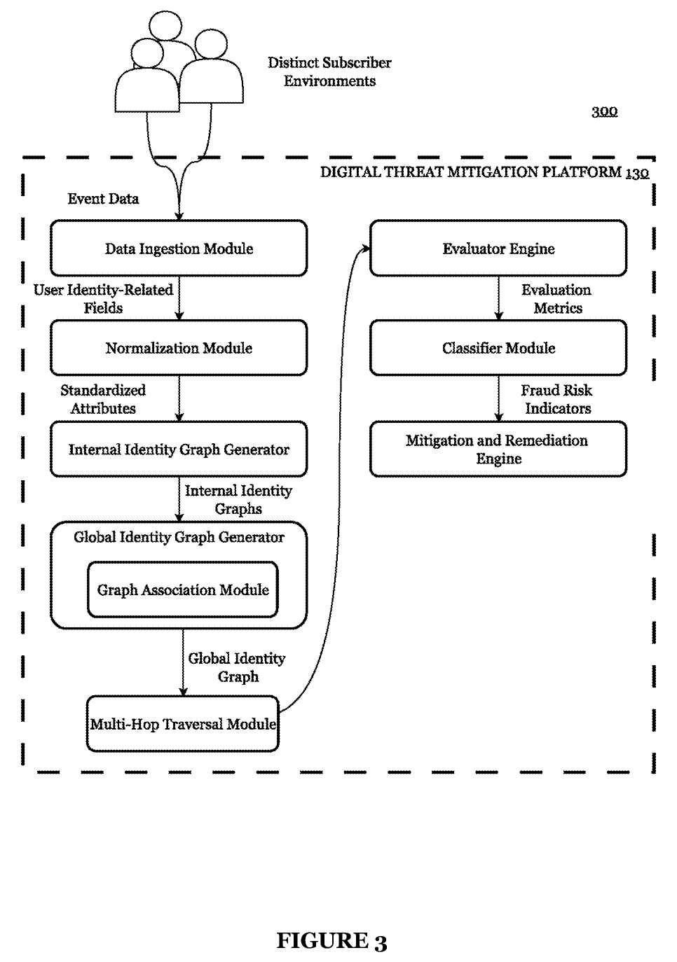

In one non-limiting example, event data generated from distinct subscriber environments may be ingested by a data ingestion module of the digital threat mitigation platform 130, as shown in FIG. 3. The event data may be transmitted over secure communication channels by one or more processors of a subscriber environment and received by a network interface of the digital threat mitigation platform 130. In an implementation, each subscriber environment may operate independently and maintain a set of distinct user accounts. The event data ingested by the data ingestion module may be generated in response to user account activities within the subscriber environments, including but not limited to authentication attempts, online purchases, funds transfers, account creation, delivery updates, and mobile application logins.

In an implementation, the data ingestion module of the digital threat mitigation platform 130 may be implemented as a combination of a network interface layer, a protocol parser, and a staging buffer. The network interface layer may be configured to establish secure connections with subscriber environments using Hypertext Transfer Protocol Secure (HTTPS), Representational State Transfer (REST) application programming interfaces, or asynchronous message queues. The protocol parser may be configured to decode incoming payloads formatted in JavaScript Object Notation (JSON), Extensible Markup Language (XML), or delimited text logs. The staging buffer may be configured to temporarily store incoming event data in a volatile memory queue prior to transmission to other components of the digital threat mitigation platform 130. The staging buffer may maintain ordering guarantees, such as first-in-first-out (FIFO) queues, to ensure temporal integrity of the received event data.

In an embodiment, the event data ingested by the data ingestion module may include structured fields such as transaction identifiers, session tokens, and timestamps, semi-structured values such as JSON objects representing account activity, and unstructured text such as free-form log entries. The data ingestion module may isolate user identity-related fields from the event data, including but not limited to email addresses, phone numbers, billing addresses, shipping addresses, device identifiers, Internet Protocol (IP) addresses, and Transport Layer Security (TLS) fingerprints (e.g., JA3 or JA4). Once isolated, the data ingestion module may encapsulate the user identity-related fields into a structured payload conforming to an internal schema of the digital threat mitigation platform 130.

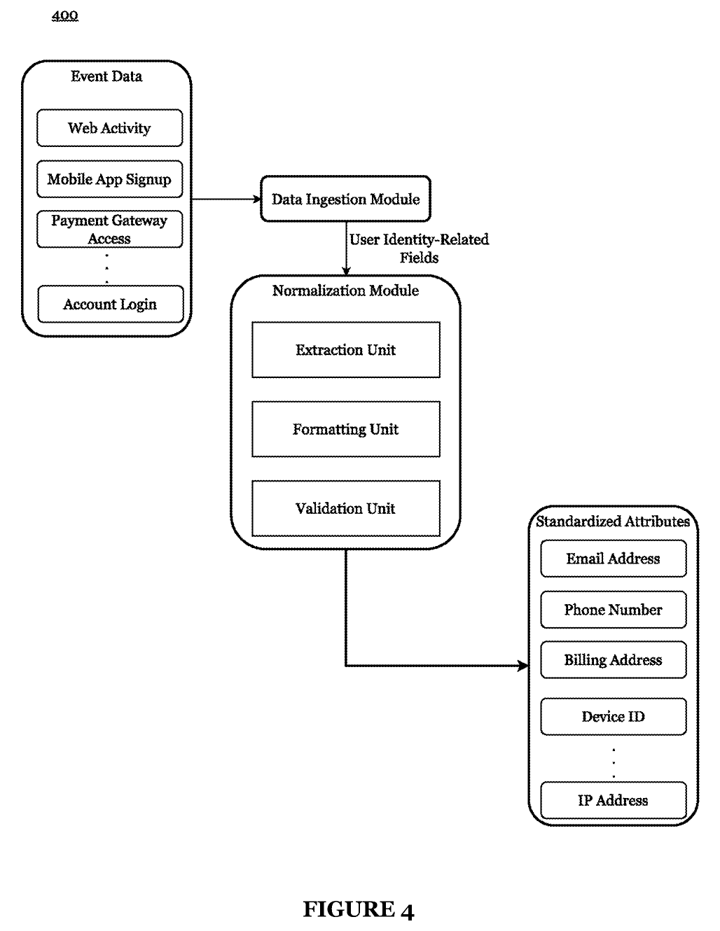

In another non-limiting example shown in FIG. 4, event data may be generated from operations within a subscriber environment, including but not limited to web activity, mobile application signups, payment gateway access, and account logins. The event data may be captured by a distributed data source of the subscriber environment and transmitted to the data ingestion module. The data ingestion module may function to isolate user identity-related fields embedded in the event data, such as an email address entered during a signup event, a phone number associated with a payment confirmation, a billing address submitted during checkout, or an IP address collected from a login request. By receiving heterogeneous event data from distributed subscriber environments and extracting user identity-related fields, the data ingestion module establishes a structured foundation for further processing within the digital threat mitigation platform 130.

### 2.20 Normalizing the Extracted User Identity-Related Fields into Standardized Attributes

S220, which includes normalizing the extracted user identity-related fields into standardized attributes, may function to transform user identity-related fields extracted in S210 into a uniform representation suitable for processing within the digital threat mitigation platform 130. S220 may include parsing, formatting, validation, and enrichment routines for converting the extracted user identity-related fields into standardized attributes. Standardized attributes may refer to user identity-related fields such as phone numbers, email addresses, billing addresses, shipping addresses, Internet Protocol (IP) addresses, device identifiers, and Transport Layer Security (TLS) client fingerprints, and the like, represented in a standardized machine-readable format. In one implementation, standardized attributes may be stored in accordance with an internal schema of the digital threat mitigation platform 130. It should be noted that standardized attributes may be referred to as user-identity-related attributes without deviating from the scope of the present disclosure.

In one implementation, S220 may include generating tokens from the extracted user identity-related fields so as to represent each token as a discrete data element. For example, a billing address such as “243 1st Street, Apt #5” may be separated into tokens representing data element “243” (street number), data element “1st Street” (street name), and data element “Apt #5” (unit designation). Each token may be stored as an independent data element in system memory, and subsequently formatted to produce standardized attributes such as “Street Number: 243,” “Street Name: First Street,” and “Unit: 5.” Stated another way, the normalization process transforms unstructured or semi-structured inputs into explicit, structured attributes that can be uniformly compared and correlated with corresponding attributes originating from other subscriber environments.

S215 may further include executing one or more rule-based transformation functions on the tokens to generate standardized attributes. For example, a phone number extracted from event data and stored in heterogeneous formats such as “+1 (408) 769-9098” or “408-769-9098” may be converted into the standardized attribute “Phone Number: +14087699098” in the E.164 format using digit-stripping routines, country-code mapping tables, and byte-length alignment checks. Similarly, an email address extracted as “HELLO_VOLHA@GMAIL.COM” may be transformed into the standardized attribute “Email Address: hello_volha@gmail.com” by executing Unicode normalization functions and lowercase conversion routines. A device identifier extracted from mobile application telemetry may be zero-padded or truncated to a fixed byte length within memory, producing a standardized attribute such as “Device ID: 92af40c8d1134b2f.” In another example, an IP address may be expressed in canonical IPv4 or IPv6 notation using bitwise formatting algorithms and reference tables, yielding a standardized attribute such as “IP Address: 192.158.1.30” or “IP Address: 2001:0db8:85a3:0000:0000:8a2e:0370:7334.

In one embodiment, the standardized attributes may further be validated and/or appended with auxiliary metadata. For example, an IP address standardized to “192.158.1.30” may be validated against reserved address ranges stored in the digital threat mitigation database 134 and appended with auxiliary metadata such as “California, USA.” Similarly, a standardized billing address may be validated against postal code formatting rules and appended with auxiliary metadata such as a latitude/longitude geocode reference. In another example, a standardized domain name may be cross-referenced against a domain reputation dataset stored in the digital threat mitigation database 134 to attach a trustworthiness score. The validated standardized attributes (with appended auxiliary metadata) may be stored in system memory or dedicated memory buffers for processing within the digital threat mitigation platform 130.

As shown in one non-limiting example of FIG. 3, event data originating from distinct subscriber environments may be processed by the data ingestion module to extract user identity-related fields. The user-identity fields may include email addresses, phone numbers, or Internet Protocol (IP) addresses. These extracted user identity-related fields may be provided as inputs to the normalization module. The normalization module may be configured to transform the extracted user identity-related fields into standardized attributes by executing formatting, validation, and enrichment operations. The generated standardized attributes may be represented as structured, machine-readable identity information that can be uniformly compared across different subscriber environments.

By way of example, user identity-related fields extracted by the data ingestion module may include a display name “J. Smith,” an email address “jsmith99@outlook.com,” and a device identifier captured as a 10-character alphanumeric string (“JS86789MOB”). The normalization module may process the user identity-related fields into standardized attributes, including “Full Name: John Smith,” “Email Address: jsmith99@outlook.com,” and “Device ID: JS86789MOB” (converted into a fixed-length format). These standardized attributes can then be stored and processed within the digital threat mitigation platform 130 for subsequent processing.

FIG. 4 illustrates one non-limiting example implementation of S215, in which user identity-related fields may be normalized into standardized attributes suitable for further processing within the digital threat mitigation platform 130. As shown, event data may be generated within a subscriber environment in response to a variety of user account operations, such as web activity, mobile application signups, payment gateway access, and/or account logins. The event data may include structured data fields (e.g., login timestamps, account identifiers), semi-structured data fields (e.g., JSON-formatted payment gateway messages), or unstructured data (e.g., free-form application log entries).

In one example, a mobile application signup event may generate event data such as an email address entered into a signup form, a phone number provided for SMS verification, and an IP address captured from the network session. The data ingestion module may parse the incoming event data and identify discrete user identity-related fields such as “Email Address,” “Phone Number,” and “IP Address.” In another example, during a payment gateway access event, the event data may include billing information entered by a user account, including a billing address, a cardholder name, and a phone number associated with the payment method. The data ingestion module may isolate this event data from the transaction payload and output user identity-related fields including “Billing Address,” “Name,” and “Phone Number.”

In an embodiment, the data ingestion module may transmit user identity-related fields to the normalization module. The normalization module may be implemented in one or more processors of the digital threat mitigation platform 130 executing computer-readable instructions stored in system memory, and may include an extraction unit, a formatting unit, and a validation unit, wherein each unit may execute discrete operations on the user identity-related fields to generate standardized attributes.

In one embodiment, the extraction unit may tokenize to structurally separate user identity-related fields into constituent components. For example, a billing address “Flat 12, 3–5 Baker St, W1U 8ED, UK” may be separated into tokens such as “Flat 12” (component: unit), “3–5” (component: street number range), “Baker St” (component: street name), “W1U 8ED” (component: postal code), and “UK” (component: country). Each token may be temporarily stored in a memory buffer as an independent data element, which enables subsequent formatting and validation routines to be applied consistently to each component of the user identity-related field. In another example, a personal name string such as “Dr. A. B. Clarke” may be separated into tokens “Dr.” (component: title), “A.” (component: given name), “B.” (component: middle initial), and “Clarke” (component: family name). The extracted tokens may be encapsulated into data objects that preserve the semantic type of each component for use by the formatting unit.

In one embodiment, the formatting unit may operate on tokens generated by the extraction unit to transform each token into a standardized attribute. For example, a phone number extracted as “(0)7700 900123” may be normalized into the standardized attribute “Phone Number: +447700900123” using a rule-based transformation function configured to apply digit-stripping routines, country-code mapping tables, and byte-length alignment checks. Similarly, an email address extracted as “J.SMITH+recover@Outlook.com” may be transformed into the standardized attribute “Email Address: j.smith@outlook.com” by executing Unicode normalization functions, lowercase conversion routines, and non-semantic tag removal. In other examples, device identifiers may be normalized into standardized attributes by padding or truncating hexadecimal byte strings to fixed lengths within memory, and IP addresses may be transformed into IPv4 or IPv6 representations using bitwise formatting algorithms and reference tables. In one implementation, the normalization module may record metadata identifying transformation functions applied to each token, so as to enable consistent reapplication and verification of the standardization process.

In one embodiment, the validation unit may perform operations to check validity of the generated standardized attributes and append auxiliary metadata to one or more standardized attributes. For example, an IP address standardized to “2a00:23c5::ab:44:0:1” may be validated against reserved ranges stored in the digital threat mitigation database 134 and appended with geographic metadata, e.g., associating the address with a location such as Manchester, United Kingdom. Similarly, a standardized attribute including billing address may be validated against postal code formatting rules and appended with geocoded latitude/longitude metadata. In another example, a standardized attribute including an email address domain may be cross-referenced against a domain reputation dataset stored in the digital threat mitigation database 134 to attach a reputation score. The validation unit may store the resulting standardized attributes together with validation status codes and appended metadata in memory buffers accessible to other components of the digital threat mitigation platform 130.

In this manner, the normalization module may transform heterogeneous, unstructured or semi-structured user identity-related fields into structured and standardized attributes that conform to an internal schema of the digital threat mitigation platform 130. By enforcing a consistent representation of user identity-related fields across distinct subscriber environments, the normalization module establishes a reliable foundation for processing unstructured user identity-related fields.

### 2.30 Constructing, Using the Standardized Attributes, Internal Identity Graphs, each Representing Direct Associations Between User Accounts Within a Subscriber Environment

S230 which includes constructing, using the standardized attributes, internal identity graphs, each representing direct associations between user accounts within a subscriber environment, may function to generate, for each subscriber environment, a computer-readable internal identity graph including user accounts represented as nodes and direct associations inferred from standardized attributes represented as edges. A direct association, as referred to herein, may exist when two or more user accounts within the same subscriber environment are associated with an identical standardized attribute (e.g., the same email address, the same phone number, the same billing address, the same device identifier, the same Internet Protocol (IP) address, or the same Transport Layer Security (TLS) client fingerprint). In one embodiment, such direct associations may also be generated by linking user accounts that share one or more identical standardized attributes without first consolidating these standardized attributes into an internal identity graph. For example, if two user accounts each report the standardized attribute “Phone Number: +14085551212,” the digital threat mitigation platform 130 may create a direct association between the two user accounts upon detecting this common standardized attribute.

In one or more embodiments, construction of an internal identity graph may begin with an internal identity graph generator of the digital threat mitigation platform 130 receiving, for a given subscriber environment, a stream or set of standardized attributes from the normalization module, as shown in FIG. 3. Each received standardized attribute may at least include data items such as a local user-account identifier, attribute type, attribute value, observation timestamp, and optional auxiliary metadata. A processor within the internal identity graph generator may write these data items to memory and instantiate a node record for the referenced user account. Each node record may include a node identifier, a set of attribute references, and provenance fields (e.g., last-seen time). It should be noted that a node record may be an example of a user node account data object as described herein.

In one or more embodiments, to identify associations among user accounts, the system may maintain, for each subscriber environment and for each attribute type, an in-memory index structure that maps attribute values to the set of user accounts that contain those attribute values. For example, the standardized attribute “Phone Number: +14087699098” may appear in multiple user accounts, and the index may record the mapping of that phone number to each associated user-account identifier. When a new standardized attribute is received, the internal identity graph generator may update the corresponding index entry and retrieve the set of user accounts already associated with that attribute value. The internal identity graph generator may then compare the newly observed user account against existing user accounts in the set, and for each pair of user accounts sharing the attribute, either create a new edge in the internal identity graph or update an existing edge to reflect the new observation.

In some embodiments, before generating an association between two user accounts, the digital threat mitigation platform 130 may apply configurable matching rules to determine whether the standardized attributes observed for the user accounts satisfy predefined conditions for creating identity-link evidence. A configurable matching rule may refer to a rule structure specifying one or more attribute types, attribute-value comparisons, normalization behaviors, or attribute-combination patterns that must be satisfied before an association is recorded. The configurable matching rules may be defined by system operators or may be derived from analytical processes that identify high-correlation attribute relationships across subscriber environments. When the standardized attributes of two user accounts satisfy the conditions of a configurable matching rule, the digital threat mitigation platform 130 may treat the matched attributes as identity-link evidence and may generate or update an edge object representing the association within the internal identity graph.

In some embodiments, a configurable matching rule may include a single-attribute condition. A single-attribute configurable matching rule may specify that two user accounts may be linked when a particular user-identity-related attribute is identical across both accounts. For example, a configurable matching rule may indicate that an association is present when two user accounts share an identical normalized email address. Satisfaction of the single-attribute configurable matching rule may result in creation of an edge object as described herein referencing the matched attribute type.

Additionally, or alternatively, a configurable matching rule may include a multi-attribute condition in which two or more user-identity-related attributes jointly satisfy predetermined comparison constraints. For example, a multi-attribute configurable matching rule may specify that two user accounts may be linked when they share both a same email address and a same IP address. Satisfaction of the multi-attribute configurable matching rule may result in creation of an edge object referencing the associated attribute types.

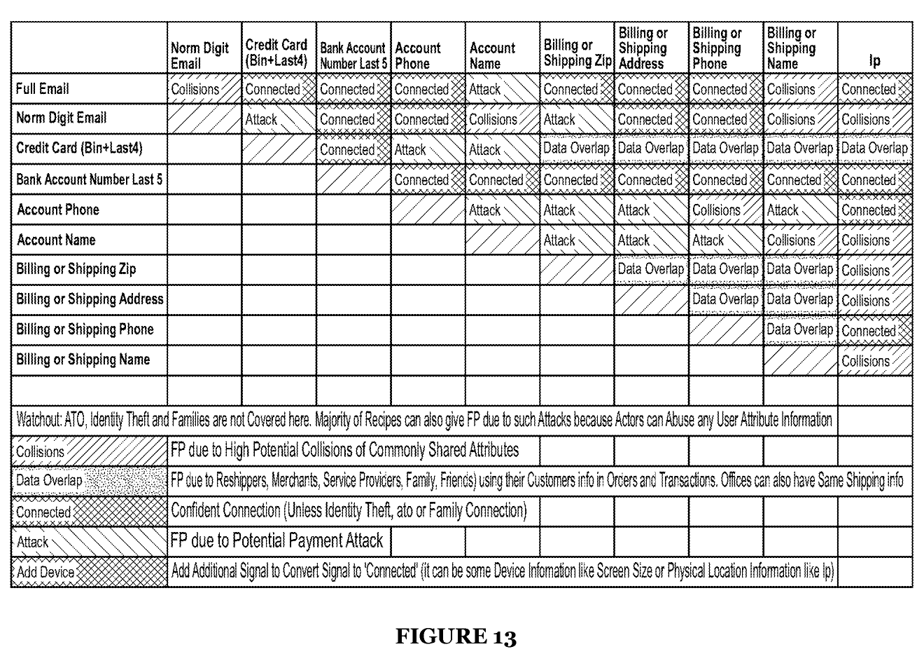

To support evaluation of multi-attribute conditions, the digital threat mitigation platform 130 may maintain a multi-attribute configurable matching rule table that defines the expected interaction between pairs of user-identity-related attributes. In one embodiment, as depicted with reference to FIG. 13, each row of the multi-attribute configurable matching rule table may correspond to a first attribute type and each column may correspond to a second attribute type. The attribute types may include one or more of a normalized email address, credit-card identifier expressed as bank-identification-number digits and last-four digits, bank account number fragment, account phone number, account name, billing or shipping postal code, billing or shipping address, billing or shipping phone number, and billing or shipping name. The configurable matching rule table may additionally include a full email address as a column attribute type. Each intersection in the configurable matching rule table may contain an outcome value representing whether the attribute pair provides reliable identity-link evidence.

The outcome values of the multi-attribute configurable matching rule table may include “collisions,” “data overlap,” “attack,” “connected,” and “add device.” A cell indicating “collisions” may correspond to attribute pairs with high expected rates of coincidental matches (e.g., the intersection of account phone number and billing-or-shipping phone number). A cell labeled “data overlap” may correspond to attribute pairs that frequently arise from shared household, workplace, merchant, or reshipper usage (e.g., the intersection of billing-or-shipping address and billing-or-shipping postal code). A cell labeled “attack” may correspond to attribute pairs susceptible to misuse during payment or account-creation abuse (e.g., the intersection of full normalized email address and account name). A cell labeled “connected” may indicate that the corresponding attribute pair (e.g., full normalized email address and credit-card identifier (BIN + last-4 digits)), provides sufficiently discriminative signal to justify creating an identity-link association. A cell labeled “add device” may indicate that the attribute pair provides partial evidentiary strength that may be elevated to “connected” when additional device-level indicators, such as a device identifier, device model, or location-based attribute, are present.

The outcome values of the multi-attribute configurable matching rule table may govern whether an association is recorded. When a table intersection yields “collisions,” “data overlap,” or “attack,” the digital threat mitigation platform 130 may refrain from generating an identity-link association due to increased likelihood of false positives. Conversely, when the intersection yields “connected,” or yields “add device” and additional device-level signals satisfy the associated conditions, the digital threat mitigation platform 130 may instantiate the corresponding configurable matching rule and record the association as identity-link evidence. These recipe-based decisions may guide the construction of edge objects in the internal identity graph and may influence downstream evaluation metrics, classifier-module outputs, and fraud-risk indicators. Alternatively, it should be noted that an association may be recorded regardless of the associated outcome value. In such examples, the outcome values may be evaluated by the evaluation engine at S270 when determining confidence scores.

When an association is recorded via the configurable matching rules described herein, an edge data object is created, where each edge object represents a respective edge of an internal identity graph. Each edge data object may include: (1) the identifiers of the two connected user accounts; (2) the attribute type and attribute value that produced the user account association; (3) timestamps for first-seen and last-seen observations; (4) a support count reflecting the number of distinct observations of the user account association; and (5) a confidence score determined by system-defined rules. For example, the confidence score may be weighted according to discriminative strength of the attribute (e.g., an exact email address match may carry more weight than a transient IP address), the recency of the use of the attribute, and the frequency of occurrence of the attribute across multiple user accounts in the subscriber environment. In one implementation, high-cardinality attributes such as shared public IP addresses may be down-weighted or capped in degree to avoid inflation of edges. For example, a weighted-scoring rule set may be used in which attributes contribute different weights to the confidence score (e.g., Email Address = 1.00, Phone Number = 0.75, Billing Address = 0.70, Device Identifier = 0.60, Shipping Address = 0.50, IP Address = 0.20, etc.). Weight of each attribute may be optionally combined with recency decay and collision penalties. In an alternative embodiment, edges of the internal identity graph may be formed only when standardized attributes are exactly equal (e.g., “Email Address: a@b.com” equals “Email Address: a@b.com”). Such edges may be treated as unit-evidence links (i.e., no additional weighting may be applied).

S230 may also include detection of attribute collisions within a subscriber environment. For instance, if a single IP address is observed as associated with an unusually large number of distinct user accounts in a short timeframe, the corresponding edges may be annotated with a collision flag and their confidence scores reduced. Similarly, repeated reuse of the same device identifier across unrelated email addresses may be marked as a device-reuse event. These annotations may remain embedded in the internal identity graph and be available for subsequent evaluation, classification, and fraud-risk scoring.

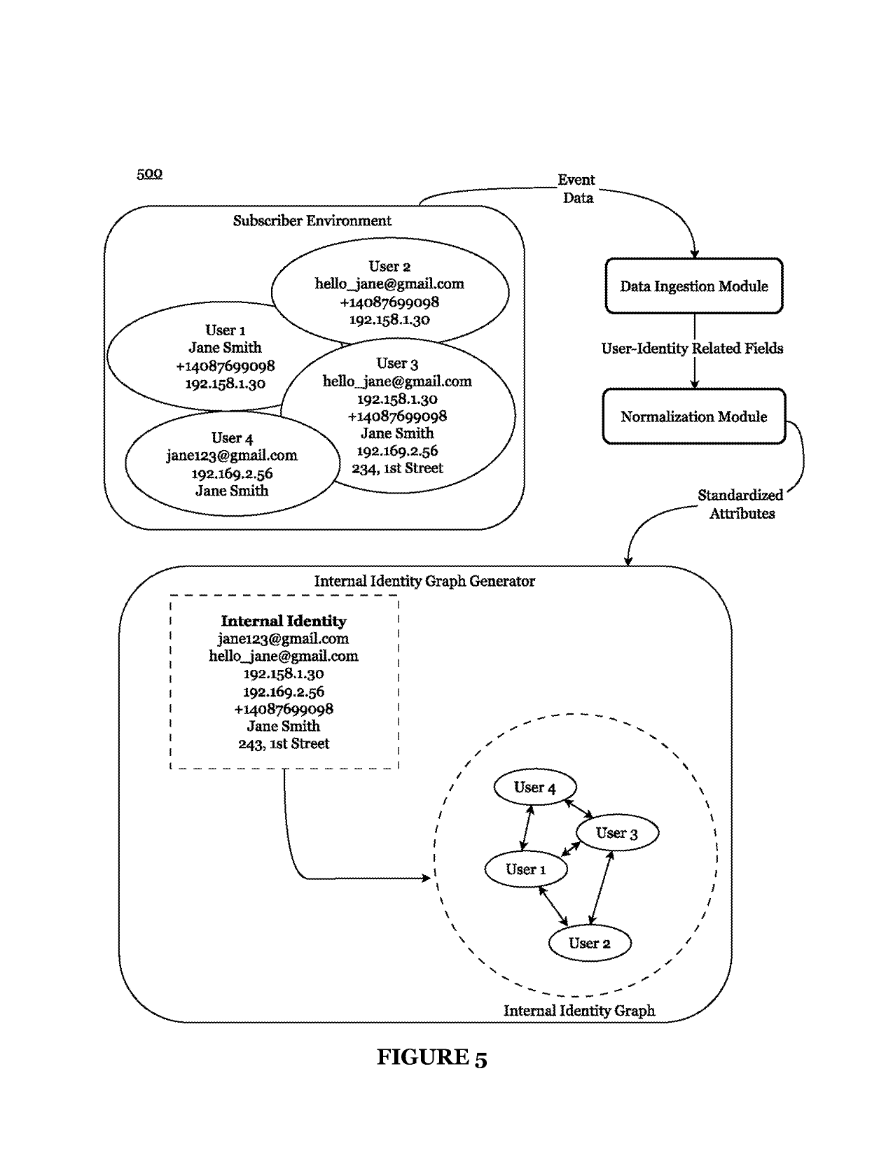

FIG. 5 illustrates an example architecture 500 for constructing internal identity graphs within a subscriber environment in accordance with process S230. As shown in the upper left portion of FIG. 5, the subscriber environment may include a plurality of user accounts, each defined by a set of user-identity related fields. For example, User 1 may be associated with the name “Jane Smith,” the telephone number “+14087699098,” and the Internet Protocol (IP) address “192.158.1.30.” User 2 may be associated with the email address “hello_jane@gmail.com,” the same telephone number “+14087699098,” and the same IP address “192.158.1.30.” User 3 may be associated with the email address “hello_jane@gmail.com,” the IP address “192.158.1.30,” the telephone number “+14087699098,” the name “Jane Smith,” an additional IP address “192.169.2.56,” and a physical address “243, 1st Street.” User 4 may be associated with the email address “jane123@gmail.com,” the IP address “192.169.2.56,” and the name “Jane Smith.” These examples illustrate how user accounts may contain overlapping fields across multiple accounts while also containing distinct information, such as a unique email address or a unique physical address.

The subscriber environment may generate event data that includes these user-identity related fields, which are received by the data ingestion module. The data ingestion module may extract the user identity-related fields and forward the user identity-related fields to the normalization module, which may transform the user identity-related fields into standardized attributes. The standardized attributes may include, for each observed user account, a local account identifier, the type of attribute (e.g., name, email, phone, IP address, or physical address), the corresponding attribute value, an observation timestamp, and optional auxiliary metadata such as validation indicators or enrichment source identifiers. For example, the normalization module may produce a standardized attribute record indicating that the attribute type is “Phone Number,” the attribute value is “+14087699098,” the account identifier corresponds to User 1, and the attribute was last observed at a particular timestamp. Another standardized attribute record may indicate that the attribute type is “Email Address,” the attribute value is “hello_jane@gmail.com,” the account identifier corresponds to User 2, and the observation metadata includes a confidence score indicating the reliability of the attribute.

In one implementation, the standardized attributes may be inputted to an internal identity graph generator, which may function to first consolidate attributes across multiple user accounts into an internal identity. As shown in FIG. 5, one example internal identity includes the consolidated attributes “jane123@gmail.com,” “hello_jane@gmail.com,” “192.158.1.30,” “192.169.2.56,” “+14087699098,” “Jane Smith,” and “243, 1st Street.” This internal identity may represent the set of standardized attributes that are observed across more than one user account and that together establish a cohesive profile for an underlying individual. The internal identity graph generator may generate a node record for each user account, store the corresponding attributes in memory, and maintain an inverted index for each attribute type that maps attribute values to the set of user accounts that contain those values. For example, the inverted index for the phone number “+14087699098” may map to User 1, User 2, and User 3, while the inverted index for the IP address “192.169.2.56” may map to User 3 and User 4.

Using these inverted indices, the internal identity graph generator may construct the internal identity graph. An exemplary graph is shown in the lower right portion of FIG. 5. The internal identity graph may include nodes that may represent the four user accounts (User 1 to User 4) and edges that represent direct associations inferred from shared standardized attributes. For instance, because User 1, User 2, and User 3 all share the same phone number (“ +14087699098”) and IP address (“192.158.1.30”), bidirectional edges may be formed among those three nodes. Similarly, because User 3 and User 4 both contain the IP address “192.169.2.56” and the name “Jane Smith,” a direct association may be formed between their corresponding nodes. Each edge may be represented in memory as a data object comprising the identifiers of the two connected user accounts, the attribute type and attribute value responsible for the user account association, timestamps indicating when the user account association was first observed and last observed, a support count reflecting the number of distinct observations of the attribute, and a confidence score determined according to system-defined rules. The confidence score may be weighted based on the discriminative strength of the attribute and may further incorporate the recency of the observation and the prevalence of the attribute across the subscriber environment.

In one or more embodiments, the internal identity graph generator may attach multiple pieces of evidentiary data to a single edge when user accounts share more than one attribute. For example, the edge between User 3 and User 4 may include both the shared IP address and the shared name, resulting in a stronger multi-evidence user account association. In some cases, parallel edges may be maintained, one for each attribute type.

Accordingly, one technical advantage of S230 is that the internal identity graph provides a computer-generated, auditable structure that enumerates user-account nodes and connects the nodes with edges derived from shared standardized attributes. Each edge may be enriched with timestamps, evidence counts, and provenance fields, and a confidence score may be dynamically adjusted according to attribute characteristics, observation recency, and patterns of attribute reuse. By capturing these associations in a structured and weighted graph representation, the system enables more accurate detection of direct user account to user account associations while mitigating the risk of false associations from low-discriminative or high-collision attributes.

### Connection Outcome Types

In some embodiments, identity associations may exhibit different connection outcome types that reflect whether the associations correspond to actual underlying user connectivity. Such connection outcome types may include true positive associations, in which two user accounts genuinely correspond to the same underlying internal identity, and true negative associations, in which two user accounts genuinely correspond to distinct internal identities. Connection outcome types may further include false positive associations, in which two distinct user accounts are incorrectly linked, and false negative associations, in which two user accounts associated with a common internal identity are not linked within an identity graph. These connection outcome types may arise from the inherent variability of standardized attributes, temporal changes in user behavior, or noise in underlying data sources, and may be used to conceptually characterize the strengths and limitations of identity-link evidence.

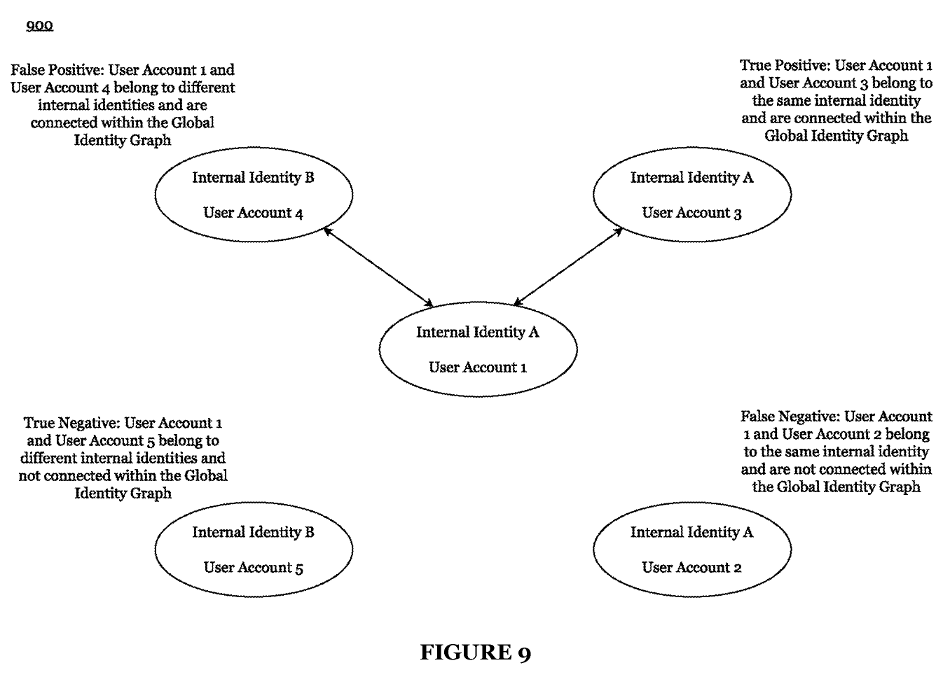

FIG. 9 illustrates representative examples of these connection outcome types in the context of identity association determinations. For instance, FIG. 9 may depict a first internal identity (i.e., Internal Identity A) associated with a first user account (i.e., User Account 1). A false positive connection outcome may occur between User Account A and another user account (i.e., User Account 4) when the digital threat mitigation platform 130 predicts that User Account 1 and User Account 4 are connected within the identity graph, but User Account 1 and User Account 4 in fact belong to different internal identities (e.g., User Account 1 associated with Internal Identity A and User Account 2 associated with Internal Identity B). Additionally, a false negative connection outcome may occur between User Account A and another user account (i.e., User Account 3) when the digital threat mitigation platform 130 predicts that User Account 1 and User Account 3 are not connected within the identity graph, but User Account 1 and User Account 3 belong to the same internal identity (e.g., both are associated with Internal Identity A).

Additionally, as illustrated in FIG. 9, a true negative may occur between User Account 1 and another user account (i.e., User Account 5) when the digital threat mitigation platform 130 correctly predicts that User Account 1 and User Account 5 are not connected within the identity graph (e.g., User Account 1 belongs to Internal Identity A and User Account 2 belongs to Internal Identity B). Further, a true positive may occur between User Account 1 and another user account (i.e., User Account 2) when the digital threat mitigation platform 130 correctly predicts that User Account 1 and User Account 2 are connected within the identity graph (e.g., both User Account 1 and User Account 2 belong to Internal Identity A).

The identity system described herein may be configured to achieve a selected operational balance between false positive and false negative outcomes (e.g., based on how matching rules are configured). In various embodiments, the balance may be adjusted according to a use case of a user utilizing the threat mitigation detection system 130. For instance, a first user prioritizing strict identity separation may prefer reduced false positives at the expense of increased false negatives, while another user prioritizing broader investigative visibility may tolerate higher false positives to reduce missed identity linkages. Additionally, or alternatively, the balance may be adjusted according to a particular utilization of identity information. For example, when identity linkages are used for automated enforcement actions, a configuration may prioritize reduction of false positive associations, whereas when identity linkages are used for investigative analytics, a configuration may tolerate a higher rate of false positive associations in order to reduce false negative outcomes.

### 2.40 Detecting Cross-User Associations Between Internal Identity Graphs from Multiple Distinct Subscriber Environments

S240, which includes detecting cross-user associations between internal identity graphs from multiple distinct subscriber environments, may function to determine whether user accounts belonging to different subscriber environments are directly associated through shared standardized attributes. As described in the foregoing, process S230 may construct internal identity graphs for each subscriber environment, in which user accounts are represented as nodes and intra-environment associations are represented as edges. While process S230 establishes user-account connectivity within a single subscriber environment, process S240 may extend these associations across subscriber environment boundaries by comparing the standardized attributes contained in the internal identity graphs.

In one or more embodiments, internal identity graphs generated by the internal identity graph generator may be transmitted to a global identity graph generator, at least comprising a graph association module, as shown in FIG. 3. The graph association module may be implemented in hardware, software, or a combination thereof. For instance, the graph association module may include one or more processors executing stored program instructions configured to perform cross-environment attribute comparisons. The global identity graph generator may further include volatile memory for storing internal identity graph data structures, non-volatile memory for storing user-account records, attribute indexes, and historical association logs. The global identity graph generator may also include high-speed input/output interfaces for receiving internal identity graphs from multiple subscriber environments as structured data feeds.

In operation, the graph association module may normalize the received internal identity graphs into a common representation suitable for cross-environment comparison. Each internal identity graph may be parsed to identity constituent user-account nodes and intra-environment edges. These user-account nodes and intra-environment edges may be written into a memory-resident registry. For each user-account node, the graph association module may extract standardized attributes, including attribute type, attribute value, and origin information.

The graph association module may then construct one or more attribute-based indexes across the internal identity graphs. Each index may map a standardized attribute value to the set of user-account identifiers from all subscriber environments that contain that attribute value. When a new standardized attribute is observed, the graph association module may update the index, and retrieve the set of user accounts already associated with the same attribute value. For example, when the same attribute value is present in two or more user accounts belonging to different subscriber environments, the module may generate a candidate cross-user association.

Each candidate cross-user association may be validated by a validator component of the graph association module. The validator may verify attribute consistency, enforce temporal validity by comparing timestamps of first-seen and last-seen observations, and apply collision detection rules. In one implementation, attributes of high cardinality, such as public IP addresses, may be assigned lower weights than attributes with strong discriminative value, such as government-issued identifiers. The validator may then assign a confidence score to each candidate cross-user association.

In one implementation, the graph association module may store cross-user associations into a datastore as structured records. Each structured record may include identifiers of the associated user accounts, identifiers of subscriber environments of origin, the attribute type and value producing the user account association, timestamps of observation, a support count indicating the number of subscriber environments contributing evidence, and a confidence score.

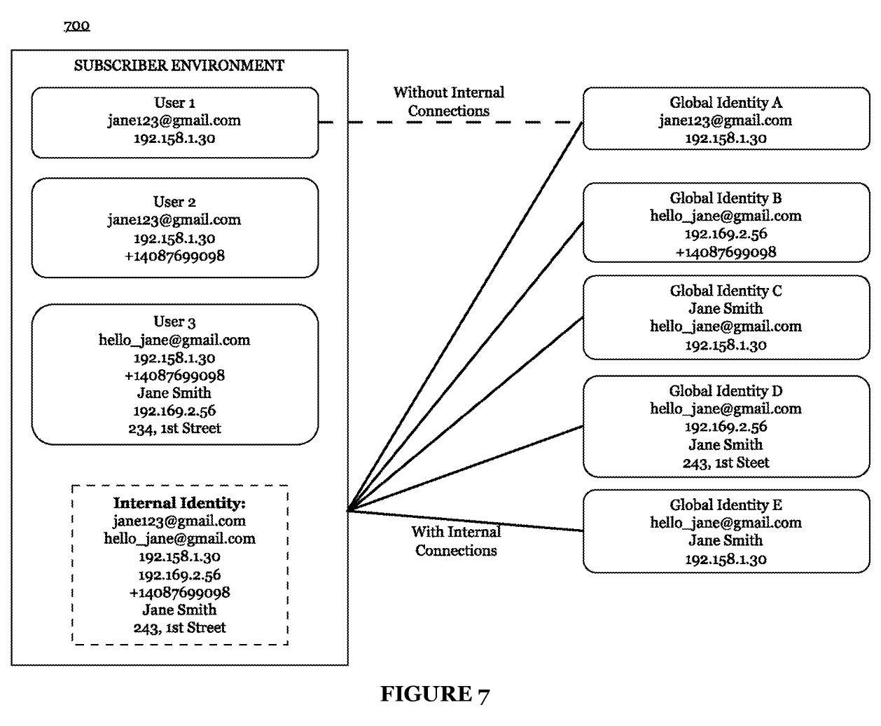

FIG. 7 illustrates one non-limiting example of cross-user associations, showing how the presence or absence of internal connections may alter the resulting cross-user associations. As shown, a given subscriber environment may include multiple user accounts. User 1 may be associated with the email address jane123@gmail.com and the IP address 192.158.1.30. User 2 may be associated with the email address jane123@gmail.com, the same IP address 192.158.1.30, and the phone number +14087699098. User 3 may be associated with the email address hello_jane@gmail.com, the IP address 192.158.1.30, the phone number +14087699098, the name Jane Smith, an additional IP address 192.169.2.56, and the street address 243, 1st Street. Based on these user accounts, the internal identity graph generator may generate an internal identity corresponding to the subscriber environment. The internal identity may consolidate overlapping attributes, including jane123@gmail.com, hello_jane@gmail.com, IP addresses 192.158.1.30 and 192.169.2.56, phone number +14087699098, the name Jane Smith, and the street address 243, 1st Street.

In an implementation, traditional fraud detection systems may not consider internal cross-user associations such that each user account may appear isolated or associated with fragmented global identities. In one such example shown in the figure, User 1 may be connected to a single Global Identity A, e.g., including attributes jane123@gmail.com and 192.158.1.30. Similarly, User 2 may connect to Global Identity B containing attributes hello_jane@gmail.com, 192.169.2.56, and +14087699098. In another example, User 3 may be associated with fragmented global identities, e.g., connecting to Global Identity C containing attributes Jane Smith and 192.158.1.30, Global Identity D containing attributes hello_jane@gmail.com, 192.169.2.56, Jane Smith, and 243, 1st Street, and Global Identity E containing attributes hello_jane@gmail.com, Jane Smith, and 192.158.1.30. In these scenarios, what is in reality a single underlying identity may be fragmented into five partial global identities. Such fragmentation may cause at-risk user accounts to go undetected because risk indicators that attach to one fragment may not propagate to the other fragments. For instance, if fraudulent transactions occur under jane123@gmail.com in Global Identity A, these transactions may not surface against the user account activity under hello_jane@gmail.com in Global Identity D. Further, genuine non-fraudulent users that may create distinct user accounts with multiple attributes, e.g., a user account with a work email and another user account with a personal email may be misinterpreted as distinct users, resulting in missed connections and under-coverage.

In one or more embodiments, the present disclosure describes determining cross-user associations based on internal connections. As shown in FIG. 7, when internal connections are considered, overlapping attributes may merge into a unified internal identity, thereby enabling the cross-user associations to correctly resolve all three accounts to the same underlying user. In one embodiment, the overlapping attributes may be merged into a single internal identity prior to cross-environment comparisons. In such a scenario, rather than producing five separate and incomplete records, using the consolidated internal identity may result in a data record associating email address attributes jane123@gmail.com and hello_jane@gmail.com, IP address attributes 192.158.1.30 and 192.169.2.56, phone number attribute +14087699098, name attribute Jane Smith, and physical address attribute 243, 1st Street as a unified identity. This unified identity may then be used by the global identity graph generator to construct a global identity graph as a single node with comprehensive attribute coverage. Further, when such a global identity graph is used to detect fraudulent activities, multiple such detections may be correlated for comprehensive threat mitigation. In one example, a fraudulent login attempt detected under jane123@gmail.com at IP address 192.158.1.30 may be correlated with suspicious order fulfillment records under hello_jane@gmail.com that may reference the same phone number +14087699098 and the same address 243, 1st Street. In another example, activity associated with a credential stuffing attack on hello_jane@gmail.com at IP address 192.169.2.56 may be correctly recognized as belonging to the same user, who also signed up for services under jane123@gmail.com. Without consolidation, these activities may be treated as occurring under different user accounts, allowing at-risk accounts to slip through undetected.

Accordingly, the graph association module enables detection of cross-user associations between internal identity graphs originating from distinct subscriber environments. By executing attribute-indexing instructions, comparison instructions, and collision-mitigation instructions, the system generates machine-readable records of user-account connectivity across environments. These associations form a foundation for constructing higher-order identity structures and strengthen the ability of the digital threat mitigation platform 130 to resolve entities spanning multiple subscriber environments.

### 2.50 Generating a Global Identity Graph by Linking User Accounts Across Multiple Distinct Subscriber Environments

S250, which includes generating a global identity graph by linking user accounts across multiple distinct subscriber environments using standardized attributes, may function to construct, for the digital threat mitigation platform 130, a computer-readable graph structure in which nodes represent user accounts and edges represent cross-environment user account associations inferred from standardized attributes. A global identity, as referred to herein, may represent a computer-generated aggregation of user accounts originating from multiple distinct subscriber environments that collectively correspond to a single underlying real-world user. Each global identity may therefore constitute a cross-subscriber construct that may link user accounts from different subscriber environments based on equivalence or correlation of one or more standardized attributes. These standardized attributes may include, but are not limited to, normalized email addresses, phone numbers, device identifiers, payment instrument fragments, or combinations of banking and address information that together provide a consistent digital signature across independent subscriber environments. By aggregating such linkages, the threat mitigation platform 130 may generate a unified, machine-interpretable profile that may represent a user presence and behavioral footprint across the entire network of subscriber environments integrated with the digital threat mitigation platform 130.

In one or more embodiments, a global identity may be implemented as a data object or graph-node structure stored in memory, where each node encapsulates metadata describing the constituent user accounts and the standardized attributes responsible for cross-subscriber linkage. Each global identity may further include provenance references to the subscriber environments from which the underlying user accounts were derived, enabling traceability and audit of the linkage process. In this manner, the global identity may serve as a higher-order digital construct that unifies fragmented user representations across disparate customer systems, thereby providing a consistent basis for performing risk correlation, behavioral analysis, and fraud-mitigation operations spanning multiple subscriber environments.

### Constructing a Global Identity Graph Based on Standardized Attributes

In one embodiment, as shown in FIG. 3, the digital threat mitigation platform 130 may include a global identity graph generator configured to construct the global identity graph directly from standardized attributes generated in S220 and stored in the digital threat mitigation database 134. The global identity graph generator may execute computer-readable instructions on one or more processors to evaluate standardized attributes collected from multiple subscriber datasets, each dataset representing user accounts of an independent subscriber environment. The processors may perform equality or rule-based comparison operations across the standardized attributes to identify cross-subscriber matches that satisfy one or more predefined attribute-combination patterns. For example, two user accounts maintained by different subscriber environments may be linked when both share the same normalized email address, or when both include the same combination of “bank-account number last five digits = 43210” and “billing address = 243 1st Street.” Upon detecting such correspondence, the global identity graph generator may generate a linkage record representing a verified cross-subscriber connection and store the linkage as an edge between the corresponding user-account nodes in the global identity graph.

In operation, construction of the global identity graph may include instantiating a node object for each user account observed across all subscriber environments, each node object storing metadata such as account identifiers, associated standardized attributes, observation timestamps, and provenance fields referencing the originating subscriber environment. When a match between standardized attributes is detected, the global identity graph generator may generate an edge object that includes the linked account identifiers, the standardized attribute(s) that produced the linkage, and timestamps of first and most recent observation.

In one embodiment, the global identity graph generator may execute in batch-processing mode, aggregating standardized attributes collected over a defined temporal window (for example, the preceding twelve months) and updating the global identity graph at configurable intervals (e.g., weekly). In another embodiment, the global identity graph generator may operate in a streaming or incremental-update configuration, wherein standardized attributes received from newly onboarded subscriber environments are continuously evaluated and linked to existing global identities in real time. Each linkage creation or update may append provenance metadata identifying the contributing subscriber environments and the recipe rule responsible for the connection, thereby ensuring transparency and auditability of each cross-subscriber association.

### Constructing a Global Identity Graph Based on Internal Identities

In another embodiment, construction of the global identity graph may begin with the global identity graph generator receiving, from the internal identity graph generator, the set of internal identities created for multiple subscriber environments, as shown in FIG. 3. Each internal identity may include a plurality of standardized attributes consolidated from user accounts in a corresponding subscriber environment. A processor within the global identity graph generator may write each received internal identity into a memory-resident registry and generate a global node record for each internal identity. Further, the processor may associate the global node record with the attributes, timestamps, and other data fields of the underlying internal identity. In one example, each global node record may include a global node identifier, a set of attribute references, a set of contributing subscriber-environment identifiers, and other data fields such as last-seen time and the number of accounts aggregated into the internal identity.

To identify cross-environment user account associations, the global identity graph generator may maintain, for each standardized attribute type, a global in-memory index structure that may map attribute values to the set of internal identities that contain those values. For example, the standardized attribute “Email Address: hello_jane@gmail.com” may appear in an internal identity from Subscriber Environment A and another internal identity from Subscriber Environment B, and the index structure may record the mapping of that email address to identifiers of both internal identities corresponding to subscriber environment A and subscriber environment B. When a new internal identity is received, the global identity graph generator may update the corresponding index structure and retrieve the set of internal identities already associated with the attribute value. The global identity graph generator may then compare the newly received internal identity against each of the previously recorded internal identities, and for each pair of internal identities sharing the attribute, either create a new edge in the global identity graph or update an existing edge to reflect the new observation.

In one or more embodiments, each edge of the global identity graph may be represented as a data object comprising: (1) the identifiers of the two connected internal identities; (2) the attribute type and attribute value that produced the cross-environment internal identity association; (3) timestamps for first-seen and last-seen cross-environment observations; (4) a support count reflecting the number of distinct subscriber environments and internal identities contributing to the cross-environment internal identity association; and (5) a composite confidence score determined by system-defined rules. In one implementation, the composite confidence score may be weighted according to the discriminative strength of the attribute (e.g., a billing address or device identifier may carry greater weight than Wi-Fi information), the recency of the observations across subscriber environments, and the diversity of the subscriber environments involved. In some embodiments, attributes of high cardinality or attributes prone to collisions, such as public IP addresses observed across multiple subscriber environments, may be down-weighted, degree-capped, or annotated with collision flags to avoid inflation of edges and to maintain discriminative value.

In one or more embodiments, the global identity graph generator may also support multi-evidence internal identity association formation. For example, if an internal identity from Subscriber Environment A and an internal identity from Subscriber Environment B share both a phone number and a billing address, the global identity graph may either attach both attribute types as separate evidentiary elements to a single edge or create parallel edges, one per attribute type, with a composite global confidence score derived for later analysis. Both approaches preserve the origin of each attribute while enabling the system to represent stronger, multi-attribute cross-environment internal identity associations.

S250 may further include detection of attribute collisions across environments. For example, if the same IP address is observed across an unusually large number of distinct subscriber environments within a short timeframe, the corresponding edges may be annotated with a global collision flag and their confidence scores reduced. Similarly, reuse of the same device identifier across otherwise unrelated internal identities from different subscriber environments may be marked as a cross-environment device-reuse event. These annotations may remain embedded in the global identity graph and are made available for subsequent evaluation, classification, and fraud-risk scoring.

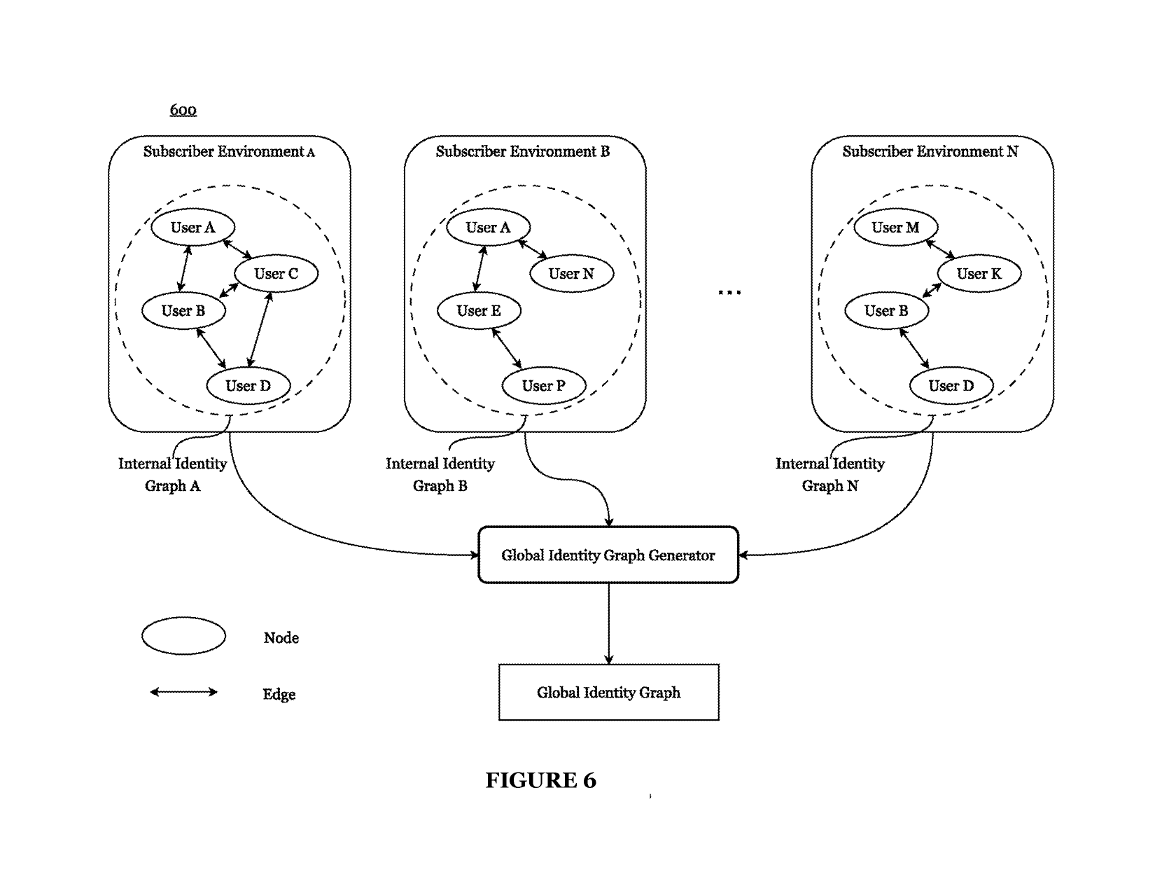

FIG. 6 illustrates one non-limiting example of architecture 600 for generating a global identity graph from multiple distinct subscriber environments (Subscriber Environments A-N). As shown in FIG. 6, Subscriber Environment A, Subscriber Environment B, and Subscriber Environment N may each include an internal identity graph (internal identity graph A, internal identity graph B, and internal identity graph N, respectively) in which user accounts are represented as nodes and intra-environment user account associations are represented as edges, as described previously with respect to process S220. For example, Subscriber Environment A may include the internal identity graph A comprising user accounts User A, User B, User C, and User D, which are interconnected. Subscriber Environment B may include internal identity graph B and user accounts User A, User E, User N, and User P interconnected therein. Similarly, Subscriber Environment N may include internal identity graph N and user accounts User M, User K, User B, and User D, interconnected therein. It is noted that each subscriber environment is shown as including four user accounts for the sake of brevity. In practice, any given subscriber environment may include tens of thousands of user accounts.

The internal identity graphs from these distinct subscriber environments may be ingested by the global identity graph generator. In one or more embodiments, the global identity graph generator may include one or more processors configured to execute software modules implementing cross-environment correlation algorithms. The global graph generator may further include volatile and non-volatile memory for storing standardized attributes and intermediate graph structures. Furthermore, the global identity graph generator may include high-speed input/output interfaces for receiving internal identity graphs from distinct subscriber environments. The global identity graph generator may further incorporate an attribute indexing module that maintains in-memory hash tables keyed by standardized attribute values, an internal identity association evaluator configured to generate candidate cross-environment internal identity associations based on shared attributes, and a graph construction engine for instantiating global node and edge objects in memory.

In operation, each internal identity from Subscriber Environment A, Subscriber Environment B, and Subscriber Environment N may be provided to the global identity graph generator. The global identity graph generator may write the received internal identities to memory and assign a global node identifier to each internal identity. The global identity graph generator may aggregate attribute occurrences from each subscriber environment. In one implementation, to establish cross-environment internal identity associations, the global identity graph generator may utilize the validated associations produced in process S240 and construct edges in the global identity graph whenever matching attributes are detected.

For example, an internal identity consolidated in Subscriber Environment A may contain a shipping tracking number derived from a prior online order. A separate internal identity consolidated in Subscriber Environment B may also include the same shipping tracking number, thereby enabling the system to generate a cross-environment internal identity association between Subscriber Environments A and B (e.g., interconnecting internal identity graphs A and B). In another example, an internal identity from Subscriber Environment N may record a federated login token issued by a third-party identity provider. Further, an internal identity from Subscriber Environment A may record the same federated token, thereby establishing a cross-environment internal identity association between Subscriber Environments A and N (e.g., interconnecting internal identity graphs A and N). In yet another example, an internal identity from Subscriber Environment B may include a hashed transaction identifier generated during payment processing, and an internal identity from Subscriber Environment N may also include the same transaction identifier, enabling the global identity graph generator to establish a cross-environment internal identity association between Subscriber Environments B and N (e.g., interconnecting internal identity graphs B and N).

In one embodiment, each edge created in the global identity graph may be represented as a structured data object that includes identifiers of the connected internal identities, the attribute type and value that triggered the cross-environment internal identity association, timestamps of first-seen and last-seen observations across linked subscriber environments, a support count indicating the number of distinct subscriber environments contributing to the edge, and a composite confidence score. The confidence score may be weighted to account for the strength of the attribute type (e.g., a federated login token being weighted higher than a shipping tracking number), the recency of the attribute observations, and the distribution of the attribute across subscriber environments.

As shown in the example FIG. 6, the global identity graph generator may output a unified global identity graph. The global identity graph may represent internal identities from multiple subscriber environments as nodes, with edges representing cross-environment internal identity associations. Each edge may be annotated with timestamps, evidence counts, identifiers, and confidence scores. The resulting global identity graph may provide a computer-generated structure that captures internal identity associations across otherwise siloed subscriber environments, thereby enabling multi-hop analysis, entity-centric risk scoring, and coordinated fraud detection at a global scale.

Accordingly, the global identity graph constructed in S225 represents a machine-readable and scalable multi-environment structure that captures direct cross-environment associations and preserves attribute-level evidence, timestamps, and origin. By elevating the graph representation from user accounts to internal identities, the system enables detection of entities spanning multiple subscriber environments.

### 2.60 Executing A Multi-Hop Traversal Instruction on The Global Identity Graph to Predict Indirect Associations Between User Accounts Across Multiple Distinct Subscriber Environments

S260, which includes executing a multi-hop traversal instruction on the global identity graph to predict indirect associations between user accounts across multiple distinct subscriber environments, may function to predict indirect associations between user accounts that may not be directly connected by a single shared standardized attribute. In the context of the present disclosure, a multi-hop traversal instruction may refer to a system-executable command that specifies traversal of two or more edges within the global identity graph to reveal indirect associations between user accounts. As described in the foregoing, a global identity graph may include a computer-readable graph structure in which nodes represent user accounts generated from subscriber environments and edges represent cross-environment user account associations inferred from standardized attributes. An indirect association, as referred to herein, may exist when two or more user accounts are linked through one or more intermediate user accounts and their associated attributes, such that the two user accounts may be connected by a path comprising multiple hops in the global identity graph.

In one or more embodiments, a multi-hop traversal module, as shown in FIG. 3, may be implemented as a distinct component of the digital threat mitigation platform 130. The multi-hop traversal module may include one or more processors executing stored traversal algorithms configured to perform breadth-first, depth-limited, and/or constraint-based pathfinding across the global identity graph. The multi-hop traversal module may further include volatile memory for maintaining traversal state information, such as visited nodes and traversal depth, and non-volatile memory for storing historical traversal results. In some implementations, the multi-hop traversal module may rely on a graph database or equivalent scalable graph-processing infrastructure to support multi-level traversals, as two-hop and three-hop connections across millions of user accounts may exceed the capacity of simple in-memory structures.

In the context of the present disclosure, traversal depth may refer to the maximum number of edges in the global identity graph that the multi-hop traversal module is permitted to traverse starting from a given user account node. A traversal depth of one corresponds to a direct connection between two user accounts based on a shared standardized attribute. A traversal depth of two corresponds to an indirect connection in which the starting user account is connected to a second user account through one intermediate user account. More generally, a traversal depth of n may correspond to a path comprising n hops across the graph, where each hop represents an edge supported by one or more standardized attributes. In one embodiment, traversal depth may be dynamically adjusted according to the strength of attributes along the path, such that high-confidence attributes permit deeper traversal while low-confidence attributes may restrict traversal depth.

In one or more embodiments, the multi-hop traversal module may receive traversal instructions originating from the provider system 140 in the form of analytic or risk-scoring requests, e.g., submitted through the web interface 120, as shown in FIG. 1. These requests may be processed by the machine learning system 132 or the warping system 133 of the digital threat mitigation platform 130, which may in turn issue multi-hop traversal instructions to the multi-hop traversal module. Each traversal instruction may specify a starting user account node, a maximum traversal depth, and optional constraints including attribute types to consider, time windows of observation, or minimum confidence score thresholds. The module may then navigate outward from the starting node along edges of the global identity graph, recording reachable nodes within the defined number of hops. Each identified path may represent an indirect association between user accounts in different subscriber environments that are not connected by a direct shared attribute.

For example, an user account originating from a financial services environment may share a payment card token with a second user account originating from an e-commerce environment, establishing a first-hop connection. The second user account may further share a shipping address with a third user account originating from a retail environment, establishing a second-hop connection. While the first and third user accounts do not directly share any standardized attributes, execution of a two-hop traversal instruction may determine that the user accounts may correspond to the same underlying user account. In another example, an user account from a healthcare environment may share a federated login token with a second user account in a government service environment, and the second user account may share a driver’s license number with a third user account in a travel service environment. The multi-hop traversal module may identify an indirect association across these three user accounts, thereby surfacing an indirect association not apparent in a single-hop view.

The multi-hop traversal module may further apply filters during traversal to mitigate noise and reduce false positives. For instance, traversal paths dependent solely on low-confidence attributes such as generic browser user-agent strings may be pruned or assigned reduced weights, since such attributes are shared by a large number of user accounts and may not reliably distinguish between individual users. Further, traversal paths exceeding temporal validity windows may be excluded, and path-level confidence scores may be computed by aggregating the scores of constituent edges. Each indirect association detected by the multi-hop traversal module may be recorded as a structured data object including identifiers of the source and destination user accounts, the sequence of intermediate nodes, timestamps for each edge in the path, the number of hops traversed, and a composite confidence score.

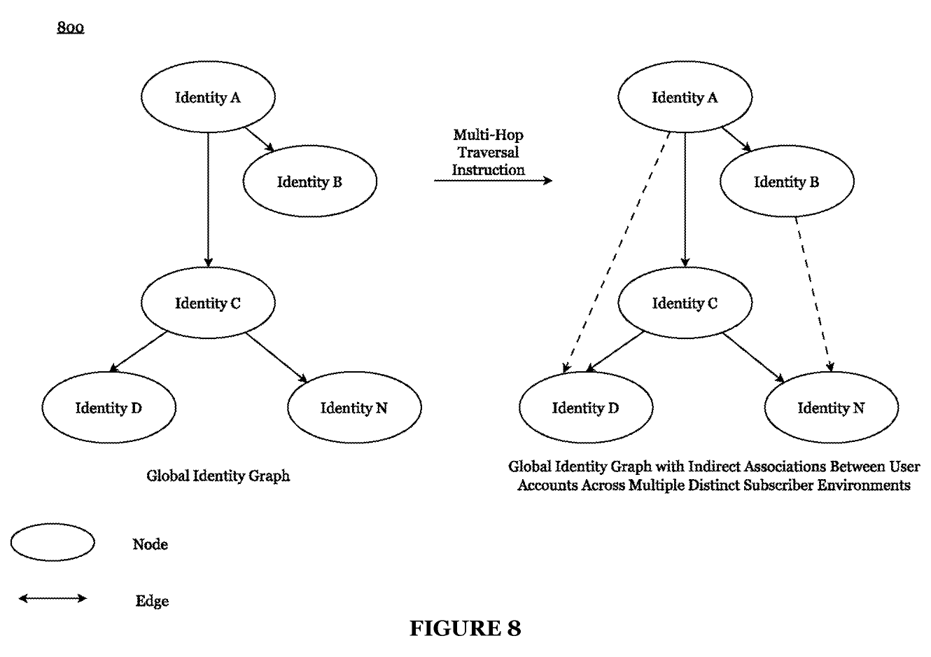

FIG. 8 illustrates one non-limiting example of execution of a multi-hop traversal instruction on the global identity graph to detect indirect associations between user accounts originating from multiple subscriber environments. As shown in the figure, a global identity graph comprises multiple user accounts such as User A directly connected to User B and User C. User C may be further directly connected to User D and User N. In this initial state, the global identity graph may encode only direct cross-environment user account associations that were inferred from standardized attributes. For example, direct user account associations may be generated based on a payment card token shared between User A and User C, or a driver’s license number shared between User C and User D. However, the indirect user account associations between multiple user accounts across subscriber environments may not be immediately detected using single-hop traversal.

In one embodiment, when the multi-hop traversal module executes the multi-hop traversal instruction, the digital threat mitigation platform 130 may be able to detect indirect associations. In the shown example, the multi-hop traversal module may traverse paths extending two or more hops from a starting identity. For instance, User A can now be indirectly connected to User D through a direct association with User C. Similarly, User B may be indirectly associated with User N by traversing through User C. The dotted edges shown in FIG. 7 may represent such indirect associations uncovered by execution of the multi-hop traversal instruction.

In one implementation, the multi-hop traversal may operate over standardized attributes that are not directly shared between the endpoints but form a chain of evidence across intermediate identities. For example, User A may be associated with a federated login token also found in User C, while User C may share a residential address with User D. Through two hops, the system may infer that User A and User D correspond to the same user. In another example, User B may include a tokenized credit card identifier shared with User C, while User C may include a frequent flyer membership number that is also present in User N. Multi-hop traversal across these attributes may reveal that User B and User N are indirectly related. In further implementations, analysis of multiple datasets (tens of thousands of user accounts) using multi-hop connections may enable surfacing fraud rings, abuse rings, and credential stuffing campaigns that may otherwise remain undetected when analysis is limited to single-hop edges.

The system may also identify indirect associations involving temporal constraints. For example, User A and User C may have overlapping device identifiers observed within the same time window, while User C and User D may share a shipping tracking number also seen within that timeframe. The traversal module may use both attribute overlap and observation time to validate the indirect path between User A and User D.

By detecting indirect associations across user accounts from multiple subscriber environments, multi-hop traversal may enable the digital threat mitigation platform 130 to build a more comprehensive representation of user behavior. In practice, fraudulent actors may often distribute activity across multiple accounts and environments to avoid detection, such as conducting account takeovers through one channel while monetizing stolen credentials through another channel. Without multi-hop analysis, such activities may appear as unrelated fragments scattered across disconnected nodes in the global identity graph. The multi-hop traversal module may allow the system to unify these fragments by tracing multi-hop paths through intermediate identities and attributes, thereby surfacing fraud rings, credential reuse patterns, and synthetic identity constructs that would otherwise remain undetected.

In an alternative embodiment, the multi-hop traversal instruction may be executed on a global identity graph generated using internal identities. In such an implementation, each node of the global identity graph may correspond to an internal identity representing a consolidated group of user accounts within a single subscriber environment, wherein the internal identity encapsulates standardized attributes, validation metadata, and intra-subscriber linkage evidence (e.g., as described in S230). The global identity graph constructed in this manner may therefore express cross-subscriber relationships between internal identities, enabling the system to model higher-order digital entities that represent the same underlying user observed across multiple subscriber environments.

In operation, during execution of the multi-hop traversal instruction, the multi-hop traversal module may perform expansion operations across nodes representing internal identities to identify indirect relationships between subscriber environments. For example, if Internal Identity A from Subscriber Environment 1 shares a normalized email address and a billing address combination with Internal Identity B from Subscriber Environment 2, and Internal Identity B further shares a device identifier with Internal Identity C from Subscriber Environment 3, the multi-hop traversal engine may infer an indirect multi-hop association between Internal Identity A and Internal Identity C.

In one embodiment, each multi-hop traversal instruction may access the underlying internal identity data structure to retrieve corroborative intra-subscriber context, such as account creation timestamps, device reuse frequency, or transaction volumes associated with the linked standardized attributes. This context may be combined with the cross-subscriber evidence recorded within the global identity graph to compute a composite confidence score for the inferred multi-hop association. Accordingly, the alternative implementation allows the digital threat mitigation platform 130 to execute the same predictive reasoning logic at a higher abstraction level, i.e., using internal identities as graph nodes, while preserving auditability, confidence weighting, and traceability of the original user-account relationships that contributed to the linkage.

Accordingly, process S260 may enable the digital threat mitigation platform 130 to uncover indirect associations across multiple subscriber environments that may otherwise remain undetected. By executing multi-hop traversal instructions on the global identity graph under defined constraints, the platform increases detection coverage, reduces false negatives associated with fragmented identities, and supports the identification of coordinated activity, fraud rings, and synthetic identity networks.

### 2.70 Computing Evaluation Metrics for Internal Identity Associations Represented in the Global Identity Graph to Quantify Reliability of Detected Associations Between User Accounts

S270, which includes computing evaluation metrics for internal identity associations represented in the global identity graph to quantify reliability of detected associations between user accounts, may function to provide systematic measurements that assess the strength, discriminative value, and risk-relevance of associations between user accounts captured in the global identity graph. In the context of the present disclosure, an evaluation metric may refer to a quantitative metric or score derived from global identity graph data that may indicate the reliability of an edge (i.e., internal identity association), node (i.e., internal identity), or subgraph in representing actual user connectivity across subscriber environments. In some implementations, the evaluation metrics may be selectively computed according to either an equality-based scheme or a weighted-scoring scheme. In the equality-based scheme, each observed standardized attribute may contribute equally toward the computed score. In the weighted-scoring scheme, each standardized attribute may contribute differently, such that the contributions may be scaled by predetermined discriminative weights. By computing such evaluation metrics, the digital threat mitigation platform 130 may transform associations inferred from standardized attributes into calibrated signals suitable for fraud detection, risk scoring, and analytic interpretation.

In one or more embodiments, the evaluation metrics may be computed by an evaluation engine implemented as part of the digital threat mitigation platform 130, as shown in FIG. 3. The evaluation engine may include one or more processors executing stored program instructions configured to perform statistical aggregation, normalization, and weighting of attributes contributing to cross-user associations. The evaluation engine may further include volatile memory for maintaining temporary graph traversal states and attribute counters, and non-volatile memory for storing historical reliability scores, collision scores, and benchmark distributions used for calibration. The evaluation engine may be communicatively coupled with high-speed interfaces to access the global identity graph constructed in S250 and the results of multi-hop traversal generated in S260.

In one embodiment, evaluation metrics computed by the evaluation engine may include support count metrics that may quantify the number of distinct subscriber environments and internal identities contributing evidence for a given association. A higher support count may indicate that the observed association is reinforced by multiple independent user accounts or subscriber environments, thereby increasing reliability of the association. The computed evaluation metrics may further include attribute-based weighting metrics that may account for the discriminative power of the standardized attribute underlying the association. For instance, a government-issued identifier may be assigned a higher weight than an email address. Similarly, a federated login token may be assigned higher weight than a shipping address. The evaluator engine may maintain a library of attribute-type weights determined through empirical analysis of historical fraud investigations, e.g., using the digital threat mitigation database 134. Alternatively, when using the equality-based scheme, the support count alone may directly determine the contribution of each observed standardized attribute. That is, each standardized attribute may be assigned the same weight.

Additionally, or alternatively, the evaluation engine may compute temporal validity metrics that may determine the consistency of an association across time. For instance, the evaluation engine may compute timestamps for first-seen and last-seen observations of each association and calculate recency-weighted scores. Associations supported only by observations before a threshold period of time may be assigned reduced reliability scores. Conversely, when a number of observations for an association exceeds a threshold number in a given period of time, the association may be assigned a higher reliability score.

In one embodiment, the evaluation engine may compute temporal validity metrics with time-window constraints to ensure that multi-hop associations spanning across unrelated time periods may not be overvalued. Stated another way, standardized attributes may appear at different times across subscriber environments, and without temporal analysis, associations may be formed between internal identities that never actually coexisted in a meaningful operational window. For example, if a payment card token was last observed in a financial services environment in 2018, and the same payment card token appears in an e-commerce environment in 2025, the gap in two observations may suggest that the two observations are not indicative of a continuous user association but rather an expired or recycled identifier. By enforcing time-window constraints, the evaluation engine may treat such an association as weak or invalid, preventing inflation of association reliability score in the global identity graph. Temporal validity metrics may therefore quantify the alignment of attribute observations within a bounded time frame, and the evaluation engine may assign higher reliability scores to associations confirmed within overlapping or recent time windows, while attenuating or discarding associations that fall outside defined temporal thresholds.

The evaluation engine may further compute collision detection and collision-penalty metrics that may identify attributes that are observed across an unusually large number of internal identities or subscriber environments. For example, an IP address associated with hundreds of user accounts in different subscriber environments within a short period of time, may indicate a shared proxy service or public access point, rather than a true user-level association. In such cases, the evaluation engine may assign a collision penalty score, reducing the overall confidence of the association. In another implementation, attributes such as family addresses, re-shipper hubs, travel agency identifiers, or gibberish values may cause inflated associations when these attributes are not down-weighted, and evaluation metrics may explicitly account for these noise sources.

In one embodiment, the evaluation engine may further compute composite confidence scores by aggregating the support count, attribute-weighting, temporal validity, and collision-penalty metrics into a single normalized value. The aggregation may employ linear weighting, probabilistic inference, or machine-learned scoring models trained on validated historical data. Composite scores may then be assigned to edges, paths, or higher-order subgraphs, enabling the digital threat mitigation platform 130 to distinguish high-confidence associations from collision-prone associations.

In one implementation, the evaluation engine may further incorporate pre-configured attribute-combination patterns derived from empirical fraud-investigation experience to refine the composite confidence scores. Each attribute-combination pattern may define a pairing or triplet of standardized attributes whose concurrent appearance across two or more user accounts or internal identities has historically been observed to be a reliable or unreliable indicator of the same individual user. For instance, two user accounts that report the same full normalized email address may often belong to the same individual. For example, an e-commerce shopping account and a ride-hailing service account that both register “jane.smith@example.com.”

In another scenario, the co-occurrence of a credit card token (e.g., defined by the banking identification number (BIN) of the credit card and last four digits) in combination with the same account phone number in two internal identities or user accounts may provide a stronger linkage than either attribute alone. For example, a fraud-ring investigation may reveal that the same credit card BIN and last four digits and the same mobile number “+1-408-555-1122” were used both to open a new wallet account and to place suspicious high-value orders at a retail marketplace.

A further example may involve the co-occurrence of a credit card token (BIN in combination with last four digits) with the last five digits of the same bank account number. For instance, a funds transfer account at a money-movement provider and a recurring billing profile at a subscription service may both reference “BIN-5234-xxxx-4321” and bank account ending “93852”, thereby strongly indicating continuity of the underlying account holder.

Other attribute-combination patterns may include a last five digits of bank account number together with the same registered account name (e.g., two user accounts both referencing a bank account ending “43210” and both registered under the name “Priya Mehta.”) Further, the last five digits of a bank account number in conjunction with the same billing or shipping address may be used as another attribute-combination pattern (two user accounts each linked to a bank account ending “78901” and both using the billing address “2431st Street, Apt #5, San Francisco, CA.”). In another example, the last five digits of a bank account number with the same billing or shipping name and/or last five digits of a bank account number coupled with the same billing or shipping phone number may also be used as attribute-combination patterns. For example, two user accounts each tied to a bank account ending “56789” and both listing “Jason Smith” as the billing contact name may be associated with the same user account. Similarly, two user accounts each linked to a bank account ending “34567” and both providing the same contact phone number “+1 408-555-9876,” may be linked to the same user account.

During evaluation, when evidence supporting an association between two user accounts or internal identities includes any of these historically validated attribute-combination patterns, the evaluation engine may adjust the composite confidence score upward to reflect the elevated reliability of the linkage. Conversely, when only weaker or partial overlaps are observed (for example, two accounts sharing only a generic email domain or a frequently reused public IP address), the evaluation engine may retain a baseline or reduced confidence score. By encoding such empirically validated attribute-combination patterns together with practical real-world examples, the evaluation engine aligns the composite confidence scores with field-proven indicators of genuine user-level connectivity, thereby improving detection coverage while reducing false positives.

The evaluation engine may further compute graph-level metrics that may assess the overall quality of the global identity graph. The graph-level metrics may include average association confidence score, distribution of path lengths required to connect internal identities, coverage percentage of internal identities with at least one cross-environment association, and/or false positive and false negative estimates derived from validation datasets.

In one embodiment, the average association confidence score may be computed by the evaluation engine to quantify the strength of internal identity associations in the global identity graph. As described earlier, each internal identity association within the global identity graph may be assigned a composite confidence score, e.g., derived from attribute weighting, temporal validity, and collision penalties. The evaluation engine may aggregate individual composite confidence scores for internal identity associations across the global identity graph and compute a mean value that represents the overall reliability of internal identity associations captured in the global identity graph. A higher average association confidence score may indicate that the majority of internal identity associations are supported by discriminative attributes, whereas a lower average association confidence score may indicate that the global identity graph is dominated by collision-prone standardized attributes. The average association confidence score may enable the digital threat mitigation platform 130 to quantify the degree of evidentiary support across the global identity graph.

The evaluation engine may further compute the distribution of path lengths required to connect internal identities. Path length, as referred to herein, may represent the number of hops traversed in the global identity graph to connect two internal identities. A distribution of path lengths may be generated by sampling across the global identity graph and determining the frequency of internal identities connected via one-hop, two-hop, or multi-hop internal identity associations. Single-hop paths may indicate direct internal identity associations, while multi-hop paths may suggest indirect or attenuated connectivity. By analyzing the path lengths, the evaluation engine may assess whether the global identity graph primarily captures direct associations or indirect associations between internal identities. The distribution of path length may provide visibility into the structural characteristics of the global identity graph.

In one or more embodiments, the evaluation engine may further compute the coverage percentage of internal identities with at least one cross-environment association. Coverage, as used herein, may be defined as the proportion of all internal identities in the global identity graph that are connected to at least one other internal identity from a distinct subscriber environment. The coverage percentage may quantify the extent to which the global identity graph links otherwise siloed subscriber environments into a unified structure. For example, if ninety percent of internal identities are connected to at least one other subscriber environment, the coverage percentage metric may indicate broad integration of internal identity data. Conversely, a low coverage percentage (e.g., less than or equal to 40 percent) may suggest that many internal identities remain isolated, i.e., are part of a single subscriber environment.

In an implementation, connectivity and coverage under single-hop versus multi-hop association strategies may be compared to provide quantitative measures of improvement as well as risks of over-association. This comparison may be executed by the evaluation engine on large-scale sample datasets, e.g., comprising ten-thousand or more user accounts, to statistically validate the reliability of the constructed global identity graph.

In operation, the computed evaluation metrics may be stored as structured records maintained in persistent storage. Each record may include identifiers of the evaluated edge or subgraph, the underlying attributes contributing to the association, computed metric values, timestamps of metric computation, and the composite confidence score. These records may then be made available to systems including the machine learning system 132, the warping system 133, and/or analytic dashboards exposed via the web interface 120.

By computing evaluation metrics for associations represented in the global identity graph, the digital threat mitigation platform 130 may ensure that entity resolution and fraud detection operations are grounded in quantifiable measures of reliability. In practice, the evaluation metrics may reduce false negatives by ensuring that fragmented but valid associations are reinforced, while simultaneously reducing false positives by penalizing noisy, collision-prone attributes. Moreover, the evaluation metrics may provide auditability by exposing the quantitative rationale behind each association, enabling fraud-detection analysts to trace why a given cross-user association was considered reliable or unreliable.

### 2.80 Generating, using the Evaluation Metrics, a Fraud Risk Indicator for each User Account in the Global Identity Graph

S280, which includes generating, using the evaluation metrics, a fraud risk indicator for each user account in the global identity graph, may function to transform the evaluation metric values generated in S270 into actionable signals that may characterize the likelihood of fraudulent or anomalous behavior of one or more user accounts represented in the global identity graph. In the context of the present disclosure, a fraud risk indicator may refer to a structured, machine-readable value or label that associates a fraud likelihood with a user account represented in the global identity graph. By computing such fraud risk indicators, the digital threat mitigation platform 130 may convert the evaluation metrics into operational outputs usable for fraud detection, monitoring, and remediation of digital threats originating from various user accounts across multiple distinct subscriber environments.

In one or more embodiments, a classifier module of the digital threat mitigation platform 130 may be configured to generate fraud risk indicators based on evaluation metrics received from the evaluation engine. The classifier module may first aggregate evaluation metric values associated with each user account and corresponding internal identity, such as support counts, attribute weights, temporal validity scores, collision penalties, composite confidence measures, and graph-level metrics. The aggregated evaluation metrics may be normalized and encoded into structured feature representations, such as numerical vectors, sparse matrices, or graph embeddings. These feature representations may be used to infer probabilistic fraud scores, e.g., using one or more machine learning models executed by the machine learning system 132.

In one non-limiting example, a gradient boosted decision tree (GBDT) model may be executed to predict a probabilistic fraud score between 0 and 1 representing the likelihood that a given user account is associated with fraudulent or anomalous activity. In this example, different evaluation metrics may populate a corresponding value in the input numerical vector. For instance, a support count of “3” (indicating three distinct subscriber environments contributing evidence for an internal identity association comprising the user account), an attribute weight of “0.9” for a government-issued identifier associated with the user account, and a temporal validity score of “0.7” may be input into the GBDT model as input corresponding to the particular user account.

The GBDT model may then process the numerical vector through an ensemble of decision trees, where each successive tree attempts to correct the errors of predecessor trees. For example, one tree may split on the temporal validity score to distinguish between outdated and recent associations, another tree may split on collision penalty scores to reduce confidence in attributes shared across large numbers of user accounts, and another tree may refine classification by combining attribute weight and composite confidence values. The outputs of these decision trees may be aggregated and weighted according to the boosting algorithm, producing a final probabilistic fraud score. For example, a final probabilistic fraud score of 0.92 outputted by the GBDT model may indicate that the evaluated user account is likely associated with fraudulent activity, while a probabilistic fraud score of 0.12 may suggest that the account is likely to be a legitimate user account.

The probabilistic fraud scores produced by the GBDT model may be continuous and interpretable, allowing them to be calibrated by the warping system 133. For example, an e-commerce subscriber environment may consider any probabilistic fraud score above 0.75 as “High Risk,” while a financial services subscriber environment may use a stricter threshold of 0.60. In this way, the GBDT model may transform evaluation metrics derived from graph-based associations into quantified probabilistic fraud scores that can be consumed by downstream systems for risk-based decision-making. In other examples, machine learning models such as pre-trained logistic regression models or neural network models may be used to generate probabilistic fraud scores. The resulting probabilistic fraud scores may thus quantify the fraud likelihood associated with user accounts across diverse subscriber environments.

In an embodiment, the adjusted probabilistic fraud scores may be recorded as fraud risk indicators associated with user accounts in the global identity graph. The fraud risk indicators may take different forms depending on implementation. In one implementation, a fraud risk indicator may be a continuous score, e.g. a score of 0.92 indicative of a high probability of fraud. In another case, the fraud risk indicator may be expressed as a categorical label, such as “High Risk,” “Medium Risk,” or “Low Risk,” derived from predefined adjusted probabilistic fraud score intervals. For example, a user account receiving an adjusted probabilistic fraud score greater than 0.85 may be assigned a “High Risk” label, an adjusted probabilistic fraud score between 0.40 and 0.85 may be assigned a “Medium Risk” label, and an adjusted probabilistic fraud score below 0.40 may be assigned a “Low Risk” label. In another implementation, the fraud risk indicator may be a composite structure that includes the adjusted probabilistic fraud score, the thresholds applied, and a set of explanatory metrics, thereby providing both a fraud likelihood and the underlying rationale.

In one or more embodiments, the digital threat mitigation platform 130 may generate a threat profile corresponding to a target user account represented within the global identity graph. The threat profile may be generated by identifying a cluster of user-account node records that includes the user-account node record corresponding to the target user account and additional user-account node records that have direct identity associations or indirect identity associations with the user-account node record corresponding to the target user account. The direct identity associations may correspond to edge data objects representing shared standardized attributes, while the indirect identity associations may correspond to multi-hop connections detected through traversal of the global identity graph as described with respect to process S260

In operation, the digital threat mitigation platform 130 may identify the cluster of user-account node records by executing traversal instructions on the global identity graph beginning from the user-account node record corresponding to the target user account. The traversal instructions may identify connected user-account node records that satisfy predetermined traversal constraints, such as maximum traversal depth, minimum confidence score thresholds, or attribute-type filtering conditions. The resulting cluster of user-account node records may therefore represent a group of user accounts that are connected through one or more identity associations inferred from shared standardized attributes or multi-hop identity relationships across multiple subscriber environments.

Once the cluster of user-account node records has been identified, the digital threat mitigation platform 130 may aggregate historical behavioral indicators associated with the cluster of user-account node records. The historical behavioral indicators may include, for example, transaction activity records, chargeback events, login attempts, device usage patterns, geographic activity indicators, account creation timestamps, fraud classification outcomes, and other operational signals associated with the linked user accounts. The historical behavioral indicators may be retrieved from the digital threat mitigation database 134 and other data repositories maintained by the digital threat mitigation platform 130.

The digital threat mitigation platform 130 may process the aggregated historical behavioral indicators using one or more processors executing computer-readable instructions stored in system memory to generate a threat profile corresponding to the target user account. In one implementation, the threat profile may be represented as a structured data object containing aggregated behavioral metrics derived from the cluster of user-account node records. The aggregated behavioral metrics may include, for example, counts of blocked transactions associated with linked user accounts, quantities of chargebacks recorded across the cluster, distributions of decision outcomes associated with the linked user accounts, geographic activity concentrations, and temporal characteristics of the linked user accounts such as account age or recency of activity.

In some embodiments, the threat profile may further incorporate evaluation metrics associated with identity associations linking the cluster of user-account node records. For example, the threat profile may include composite confidence scores associated with identity associations, support counts indicating the number of subscriber environments contributing evidence for an association, and collision indicators corresponding to attributes observed across large numbers of user accounts. By incorporating both behavioral indicators and identity association metrics, the threat profile may provide a consolidated representation of risk conditions associated with the target user account and its connected identities.

The generated threat profile may be stored within the digital threat mitigation database 134 and associated with the user-account node record corresponding to the target user account. The threat profile may subsequently be used by the classifier module during generation of fraud risk indicators described with respect to process S280, by the mitigation and remediation engine during execution of threat mitigation instructions described with respect to process S290, or by the query interface described herein to provide identity-based investigative insights to analysts or automated fraud-detection systems.

Accordingly, S280 enables transformation of evaluation metrics into structured, machine-readable outputs, for accurate differentiation between genuine and spurious associations, reducing false positives caused by noisy or collision-prone attributes, and minimizing false negatives by reinforcing weak but valid associations. Additionally, the fraud risk indicators, whether expressed as continuous scores or categorical risk labels, can be directly consumed by analytic dashboards and/or remediation workflows, thereby improving both the speed and precision of fraud detection, while providing explainable, auditable rationales for each user account classification.

### 2.90 Executing a Plurality of Threat Mitigation Instructions Based on Fraud Risk Indicators Associated with User Accounts

S290, which includes executing a plurality of threat mitigation instructions based on fraud risk indicators associated with user accounts, may function to initiate system-level and subscriber-level actions that suppress spurious associations, elevate high-risk user accounts for further review, and/or autonomously enforce access-control and fraud-prevention measures. In the context of the present disclosure, a threat mitigation instruction may refer to a computer-executable command generated by the digital threat mitigation platform 130 to modify, restrict, or otherwise control the operation of one or more user accounts across subscriber environments in response to identified fraud risk. In an embodiment, S290 may be executed by a mitigation and remediation engine of the digital threat mitigation platform 130, based on the fraud risk indicators, received from the classifier module, as shown in FIG. 3.

In one or more embodiments, S290 may include an integration and targeting phase followed by an enforcement phase. During the integration and targeting phase, the mitigation and remediation engine may output structured payloads containing fraud risk indicators and explanatory metadata to third-party cybersecurity systems such as but not limited to Security Orchestration, Automation, and Response (SOAR) platforms, Security Information and Event Management (SIEM) systems, and/or subscriber-specific fraud management consoles. The structured payloads may identify the specific scope of action, such as isolating a particular internal identity, suppressing propagation across a misclassified edge in the global identity graph, or flagging high-risk transaction types in a given subscriber environment.

During the enforcement phase, the mitigation and remediation engine may execute a plurality of discrete threat mitigation instructions, which may also be referred to as a workflow rule. In one non-limiting example, the mitigation and remediation engine may automatically place one or more user accounts into a limited-functionality mode that may require additional authentication factors. In another example, the mitigation and remediation engine may suppress spurious edges in the global identity graph to prevent risk propagation across misclassified associations. Further, the mitigation and remediation engine may also initiate a block or hold on high-risk transactions originating from user accounts with fraud risk indicators above a predefined threshold or propagate risk signals to subscriber-environment security gateways to trigger adaptive rate-limiting, credential resets, or real-time user account lockouts.

In one implementation, the mitigation and remediation engine may execute distinct threat mitigation instructions for each subscriber environment based on environment-specific rules. For example, a threat mitigation instruction for a financial services environment may automatically initiate freezing high-value wire transfers for accounts marked “High Risk.” In another example, a threat mitigation instruction for an e-commerce environment may route suspected malicious accounts to fraud analysts through a graphical user interface that displays fraud risk indicators and supporting evaluation metrics. This approach ensures that threat mitigation instructions are aligned with the operational and regulatory requirements of each subscriber environment while maintaining a unified fraud-detection architecture.

In one or more embodiments, the plurality of threat mitigation instructions may further include execution of a recipe design instruction. The recipe design instruction may function to define, maintain, and dynamically adjust structured combinations of fraud risk indicators and evaluation metrics that may be applied to user accounts represented in the global identity graph. A “recipe design”, as used herein, may refer to a configurable set of rules, parameter thresholds, and model-specific features stored in machine-readable data structures and executed by one or more processors, that may govern how risk is assessed and subsequent mitigation actions may be triggered for a given subscriber environment.

In operation, the recipe design instruction may be executed by the mitigation and remediation engine to select one or more evaluation metrics, such as temporal validity scores or collision penalties, and apply subscriber-specific thresholds that determine whether the fraud risk indicators escalate into high-risk classifications. The correlation of outcomes to actions may be implemented through conditional logic tables, weighted decision functions, and/or stored model parameters executed at runtime, thereby ensuring that these correlations may be executed deterministically and reproducibly.

In one implementation, the recipe design instruction may enable subscriber environments to maintain multiple concurrent recipe designs, each tailored to distinct operational contexts. For instance, an e-commerce subscriber environment may configure a recipe design that emphasizes attribute weighting metrics for email and shipping addresses. In another example, a financial services environment may configure a recipe design that may emphasize attribute weighting on government-issued identifiers and temporal validity windows. By allowing flexible configuration, the recipe design instruction may enable mitigation instructions to adapt to sector-specific risks without requiring global changes to underlying classification models. Each recipe design may be instantiated as a separate executable profile maintained in persistent storage and retrieved by the mitigation and remediation engine, e.g., responsive to subscriber environment identifiers or policy triggers.

In another embodiment, recipe designs may be dynamically updated by the digital threat mitigation platform 130 in response to feedback derived from subscriber environment accounts. For example, if repeated false positives are traced to device fingerprint collisions, the recipe design may be automatically updated to down-weight device identifiers as input features, while retaining other evaluation metrics. In an implementation, updates may be performed through incremental retraining of the associated decision models, modification of feature-weighting coefficients, or regeneration of conditional logic rules, with updated recipe design version-controlled to preserve auditability.

By incorporating recipe design instructions, the digital threat mitigation platform 130 may provide a structured, transparent, and tunable mechanism for converting fraud risk indicators into subscriber-specific mitigation strategies, thereby improving operational efficiency, reducing analyst workload, and ensuring that mitigation actions remain aligned with evolving threat patterns across diverse subscriber environments.

In one or more embodiments, the digital threat mitigation platform 130 may further include a query interface configured to enable retrieval of identity association information stored within the global identity graph. The query interface may be implemented as a software module executed by one or more processors of the digital threat mitigation platform 130 and communicatively coupled to the digital threat mitigation database 134. The digital threat mitigation database 134 may store the global identity graph together with associated node records, edge data objects, traversal outputs, evaluation metrics, and other data structures generated during processes S230 through S270.

In operation, the query interface may receive a query originating from a provider system 140, an analyst workstation, or an automated analytic workflow executed by the digital threat mitigation platform 130. The query may identify a target user account through one or more query parameters including a digital user-account identifier, a standardized attribute value, or a combination of user-identity-related attributes associated with the target user account. For example, the query may include an email address, a phone number, a device identifier, an Internet Protocol (IP) address, or other standardized attributes previously extracted and normalized during processes S210 and S220.

Responsive to receiving the query, the query interface may execute lookup instructions to locate a corresponding user-account node record within the global identity graph. In one implementation, the lookup instructions may access attribute-based index structures maintained by the digital threat mitigation platform 130 that map standardized attribute values to user-account identifiers or internal identity identifiers represented in the global identity graph. The query interface may therefore identify the user-account node record corresponding to the target user account by comparing the query parameters with standardized attributes stored in the index structures.

Once the corresponding user-account node record is identified, the query interface may retrieve identity association information associated with the user-account node record. The retrieved identity association information may include direct identity associations represented by edge data objects linking the user-account node record to other user-account node records, as well as indirect identity associations discovered through multi-hop traversal of the global identity graph as described with respect to process S260. The retrieved identity association information may further include associated metadata such as timestamps of observation, attribute types and values responsible for the associations, support counts, evaluation metrics, and confidence scores associated with the identity associations.

In one or more embodiments, the query interface may generate a structured digital object representing the retrieved identity association information. The structured digital object may include identifiers of the target user-account node record, identifiers of connected user-account node records that have direct identity associations or indirect identity associations with the target user-account node record, and metadata describing the associations linking the node records. The structured digital object may further include data derived from evaluation metrics computed during process S270 or fraud risk indicators generated during process S280.

The generated structured digital object may be transmitted by the digital threat mitigation platform 130 to a requesting system, such as the provider system 140, or provided to a threat mitigation graphical user interface for presentation to an analyst. By enabling retrieval of identity association information using query parameters associated with a target user account, the query interface may facilitate investigative analysis, automated fraud detection workflows, and real-time evaluation of identity relationships represented within the global identity graph.

In one or more embodiments, the digital threat mitigation platform 130 may generate one or more visualization artifacts configured to represent identity associations detected within the global identity graph. A visualization artifact, as referred to herein, may correspond to a structured data object generated by the digital threat mitigation platform 130 that encodes visual elements for presentation at the threat mitigation graphical user interface. The visualization artifact may represent identity relationships between user accounts and may enable analysts or automated systems to visually evaluate identity associations derived from standardized attributes and multi-hop traversal analysis.

In one implementation, the visualization artifact may be generated responsive to a query associated with a target user account, as described with respect to the query interface of the digital threat mitigation platform 130. The query interface may identify a user-account node record corresponding to the target user account within the global identity graph and may retrieve data describing direct identity associations and indirect identity associations connected to the user-account node record. The retrieved identity association information may then be processed by one or more processors of the digital threat mitigation platform 130 to generate the visualization artifact.

The visualization artifact may include one or more user-account node visualization objects corresponding to user-account node records represented in the global identity graph. Each user-account node visualization object may represent a respective digital user account and may be associated with metadata including identifiers of the corresponding user-account node record, subscriber-environment classifications associated with the digital user account, and aggregated behavioral indicators associated with the digital user account. The visualization artifact may further include one or more edge visualization objects corresponding to edge data objects that represent identity associations between user-account node records. Each edge visualization object may therefore represent a direct identity association or an indirect identity association between two user-account node records identified through shared standardized attributes or multi-hop traversal relationships.

In one or more embodiments, the visualization artifact may further include summary visualization objects configured to present aggregated behavioral indicators associated with a cluster of connected user accounts. The summary visualization objects may include data representing transaction metrics, fraud classification outcomes, quantities of chargebacks, or other operational indicators aggregated across user-account node records linked to the target user account. The summary visualization objects may therefore enable analysts to rapidly evaluate behavioral patterns associated with identity clusters represented in the global identity graph.

In some implementations, the visualization artifact may further include one or more interactive control elements configured to enable execution of threat mitigation actions directly from the threat mitigation graphical user interface. The interactive control elements may correspond to selectable interface components that, when activated through analyst input, trigger execution of workflow rules by the mitigation and remediation engine of the digital threat mitigation platform 130. The workflow rules may modify the operational state of a target user account, such as initiating additional authentication requirements, blocking transactions associated with the target user account, or routing the target user account to a fraud analyst interface for further investigation.

In certain embodiments, the visualization artifact may be generated while withholding one or more underlying user-identity-related attributes used to construct the global identity graph. For example, personally identifiable information associated with standardized attributes, such as email addresses, phone numbers, or billing addresses, may be excluded from the visualization artifact. Instead, the visualization artifact may encode identity associations using abstracted identifiers corresponding to user-account node records and edge data objects. By restricting exposure of underlying standardized attributes, the digital threat mitigation platform 130 may enable analysts to evaluate identity associations and risk conditions without accessing sensitive user-identity-related information, thereby supporting privacy-preserving investigative workflows.

The visualization artifact generated by the digital threat mitigation platform 130 may be transmitted to the threat mitigation graphical user interface for rendering as interactive visual elements. In this manner, the visualization artifact may enable visual exploration of identity relationships, fraud indicators, and behavioral characteristics associated with clusters of linked user accounts represented in the global identity graph.

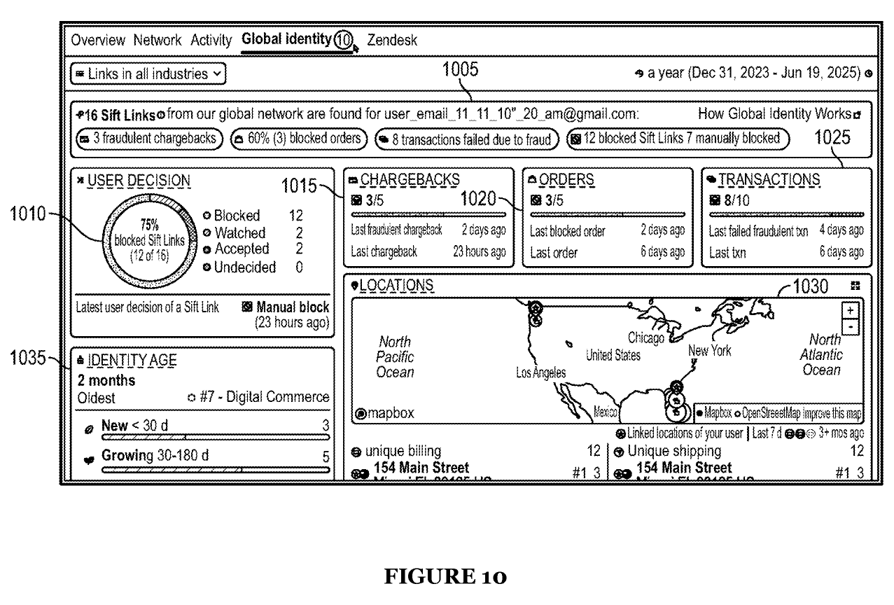

The threat mitigation instructions described above may be surfaced to an analyst through a threat mitigation graphical user interface that may allow the analyst to observe the evidentiary basis for detected identity associations, review automated or historical decision outcomes, and apply additional mitigation actions when necessary. FIG. 10 illustrates an example of such a threat mitigation graphical user interface configured to display, for a selected user account, a consolidated presentation of identity-link evidence derived from the global identity graph together with associated decision outcomes, transactional statistics, geospatial and temporal patterns, and analyst-action controls.

As shown in FIG. 10, the threat mitigation graphical user interface rendered by the digital threat mitigation platform 130 may provide an analyst-facing environment that consolidates identity-link evidence and risk-relevant outcomes for a user account under review. The information may be encapsulated in a risk profile for the user account under review. The threat mitigation graphical user interface may present, within panel 1005, an identifier of the reviewed user account together with a counter indicating a total number of external linked user accounts detected over a defined historical observation period, each external link being established on the basis of at least one predefined attribute-combination pattern. The threat mitigation graphical user interface may further display, within panel 1005, an aggregated summary of analyst or system-initiated decision outcomes for the linked users, such as a combined total in which a first subset of the linked users has been blocked, a second subset placed on watch, a third subset accepted as benign, and a residual subset, if any, left undecided. The threat mitigation graphical user interface may also provide cumulative transactional indicators including, by way of example, a number of chargebacks recorded for the linked users together with a count of chargebacks classified as fraud-related (e.g., within panel 1015), a number of historical orders placed by the linked users together with a count of orders blocked as fraudulent (e.g., within panel 1020), and a number of recent transactions processed for the linked users together with counts of transactions declined and approved respectively (e.g., within panel 1025).

In some implementations, the threat mitigation graphical user interface may present a visual indicator such as a radial gauge (e.g., radial gauge 1010) to depict proportions of blocked, watched, accepted, and undecided linked users. The threat mitigation graphical user interface may further include a geospatial map panel 1030 (e.g., a geographic visualization object) presenting geographic region identifiers derived from location-related attributes associated with linked user accounts represented in the global identity graph. The geographic region identifiers may be derived by the digital threat mitigation platform 130 based on standardized attributes associated with user-account node records, including billing addresses, shipping addresses, Internet Protocol (IP) address geolocation data, device location telemetry, or other location-indicating attributes extracted from digital event records. The geographic visualization object may display geographic regions associated with the linked user accounts without exposing the underlying user-identity-related attributes used to derive the geographic regions. The map may be capable of distinguishing between recently observed locations and locations observed in more distant historical periods and of highlighting concentrations of activity in particular regions such as a single state, country, or metropolitan area.

The threat mitigation graphical user interface may further display information describing temporal characteristics of the linked identities (e.g., within panel 1035), for example the age of the oldest linked identity and distributions of other linked identities across defined age ranges such as less than thirty days, between thirty and one hundred eighty days, and greater than one hundred eighty days. An industry or segment selector may be provided to filter the linked identity statistics so that an analyst may be able to view linkages and outcomes restricted to a selected vertical such as e-commerce, online gambling, or digital commerce.

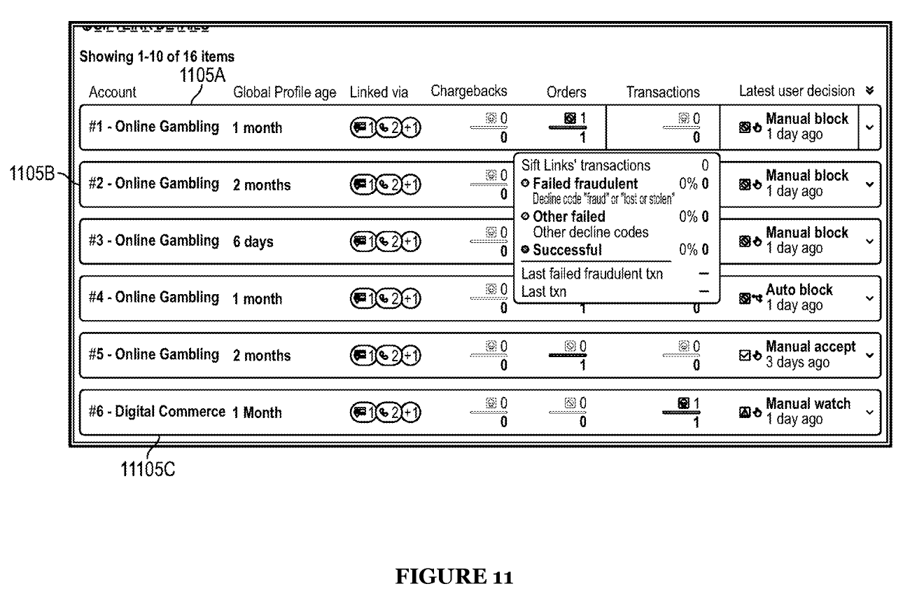

The threat mitigation graphical user interface may further provide an interactive listing of the external linked user accounts in a tabular format, such as depicted in FIG. 11. It should be noted that the user accounts within the interactive listing may be grouped according to subscriber-environment classifications (e.g., which industry is associated with the user account). For instance, a first entry 1105A and a second entry 1105B of the interactive listing may be associated with a same subscriber-environment classification (e.g., online gambling) and may thus be grouped together. Additionally, a third entry 1105C may correspond to a different subscriber-environment classification (e.g., digital commerce) from the first entry 1105A and the second entry 1105B. Accordingly, the third entry 1105C may be grouped separately from first entry 1105A and second entry 1105B.

The interactive listing of external linked user accounts may enumerate, for each linked user, the attribute-combination pattern responsible for creating the link, the mitigation decision currently associated with that linked user, and one or more usage or transaction metrics such as a number of orders, a number of chargebacks, or a number of declined transactions. In some cases, the table may indicate that a particular linked user was connected to the reviewed user account by a shared billing address and a shared phone number and that the account was subject to a manual block decision entered by an analyst. The threat mitigation graphical user interface may further include analyst-action controls enabling the analyst to initiate mitigation actions such as a manual block or an escalation for further review against any of the linked users, and such actions may be stored by the platform as threat-mitigation instructions associated with the reviewed account.

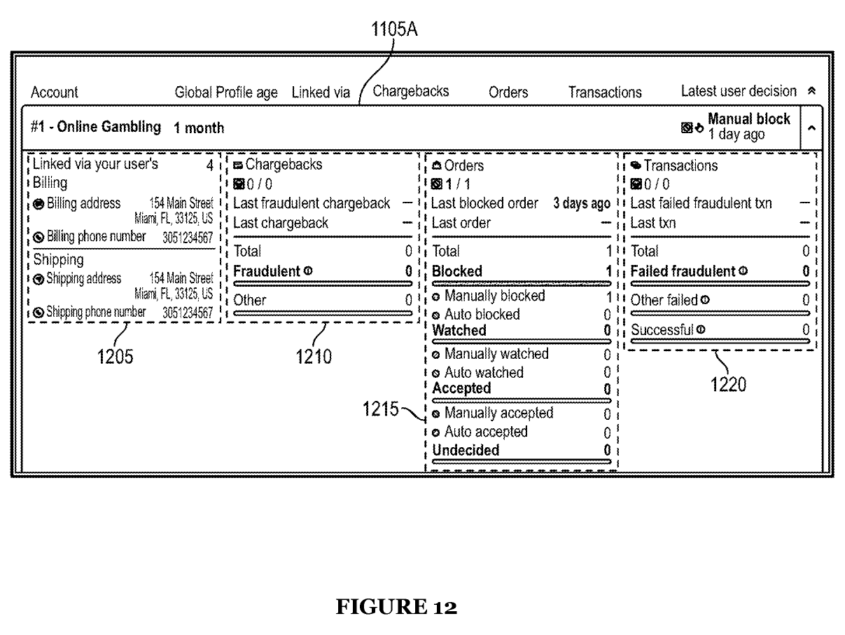

In some embodiments, each entry within the interactive listing may be selectable in order to reveal additional information. For instance, if entry 1105A of the interactive listing is selected, an expandable menu, as depicted in FIG. 12, may appear that includes panels 1205, 1210, 1215, and 1220. Panel 1205 may indicate one or more user-identity-related attributes of an external linked user account that matches a reviewed user account (e.g., billing address, billing phone number, shipping address, shipping phone number). Panel 1210 may provide information associated with detected chargebacks for the external linked user account, panel 1215 may provide information associated with orders for the external linked user account, and panel 1220 may provide information associated with transactions for the external linked user account.

It should be noted that the threat mitigation graphical user interface may present aggregated risk information while intentionally withholding the underlying standardized attributes used to construct the global identity graph. For instance, the risk profile depicted in FIG. 10, the interactive listing of linked user accounts as depicted in FIG. 11, and the expanded entry as depicted in FIG. 12 may withhold information related to personally identifiable information associated with a user account (e.g., a name of a user or an associated email address). By restricting the interface in this manner, the platform may enable analysts to review identity-link insights and evaluate risk conditions without accessing sensitive user-identity-related attributes, thereby maintaining consistency with internal privacy controls and reducing exposure of personally identifiable information during analyst review.

In some implementations, the threat mitigation graphical user interface may surface indicators of coordinated activity suggestive of a fraud ring or abuse ring. The digital threat mitigation platform 130 may evaluate connectivity characteristics exhibited by the external linked user accounts, including quantities of shared attribute-combination patterns, recurrence of high-risk decision outcomes, and concentration of transactional anomalies across multiple linked users, to determine whether the linked users collectively represent a correlated pattern of malicious behavior. Responsive to detecting such coordinated activity, the threat mitigation graphical user interface may generate an alert or visual indication identifying the presence of a suspected fraud ring or abuse ring and may highlight the subset of linked users contributing to the pattern within the visual panels or tabular displays. The alert may enable an analyst to recognize that the reviewed user account forms part of a broader coordinated structure and may facilitate analyst-initiated or automated mitigation actions through the interface-provided controls.

By consolidating in a single operational environment the evidentiary basis for link creation, the historical transactional outcomes of the linked users, geospatial and temporal patterns of the linked identity cluster, industry-specific filtering, and direct controls for imposing mitigation actions, the threat mitigation graphical user interface illustrated in FIG. 10 may enable analysts to evaluate identity-based risk with improved speed and accuracy and to implement responsive fraud-mitigation measures in real-time investigative workflows.

Accordingly, a technical advantage of S290 may include the digital threat mitigation platform 130 providing an end-to-end feedback loop that not only identifies anomalous or fraudulent activity but also integrates the findings into subscriber workflows and enforces corrective actions at scale. The incorporation of environment-specific rules enables differentiated handling of fraud risk across e-commerce, financial services, and other domains without compromising platform-wide consistency. The combined use of fraud risk indicators, expansion attributes, and subscriber-tailored mitigation instructions enables systematic reduction of fraud exposure, faster analyst triage, and more accurate suppression of coordinated fraud campaigns across heterogeneous subscriber environments.

In one or more embodiments, the digital threat mitigation platform 130 may further evaluate a quantity of identity associations linking a target user-account node record to other user-account node records classified as high-risk. A high-risk user-account node record may correspond to a node associated with a fraud risk indicator exceeding a predefined risk threshold generated by the classifier module described with respect to process S280. The mitigation and remediation engine may determine a count of direct identity associations and indirect identity associations connecting the target user-account node record to the high-risk user-account node records within the global identity graph. When the count of such associations exceeds a predefined association quantity threshold stored within a configuration profile of the digital threat mitigation platform 130, the mitigation and remediation engine may adjust the fraud risk indicator associated with the target user-account node record to indicate an elevated likelihood of fraudulent or abusive behavior. In some implementations, the predefined association quantity threshold may be dynamically configurable according to subscriber-environment policies, historical fraud patterns, or attribute confidence scores associated with the identity associations contributing to the count. By evaluating the concentration of connections to high-risk user accounts within the global identity graph, the digital threat mitigation platform 130 may propagate risk signals across identity clusters and improve detection of coordinated abuse networks and fraud rings.

In one or more embodiments, the mitigation and remediation engine of the digital threat mitigation platform 130 may further evaluate operational characteristics associated with a target user account, including an age of the digital user account corresponding to the user-account node record. The age of the digital user account may be determined based on a difference between a current timestamp and an account-creation timestamp associated with the digital user account. When the age of the digital user account is below a predefined age threshold, the mitigation and remediation engine may evaluate identity associations linking the target user-account node record to other user-account node records having fraud risk indicators below a predefined low-risk threshold. In such implementations, when a quantity of direct or indirect identity associations between the target user-account node record and the low-risk user-account node records exceeds a predefined association quantity threshold, the mitigation and remediation engine may determine that the target digital user account exhibits behavioral similarity with trusted accounts. Based on such determination, the mitigation and remediation engine may execute one or more mitigation instructions that enable increased functionality of the target digital user account, including allowing transactions associated with the target digital user account or permitting operation of the target digital user account using a same number of authentication factors as the associated low-risk user accounts. By incorporating account age and association patterns with low-risk identities into mitigation decisions, the digital threat mitigation platform 130 may reduce false positives for newly created accounts while maintaining protection against coordinated abuse activity.

### 3. Computer-Implemented Method and Computer Program Product

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

The system and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of the processors and/or the controllers. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although omitted for conciseness, the preferred embodiments include every combination and permutation of the implementations of the systems and methods described herein.

As a person skilled in the art will recognize from the previous detailed description and from the figures and claims, modifications and changes can be made to the preferred embodiments of the invention without departing from the scope of this invention defined in the following claims.

We claim:

1. A method for identifying digital fraud or digital abuse within one or more online environments, the method comprising:
obtaining, from one or more distributed data sources, a plurality of digital event records associated with a plurality of online subscriber environments;
extracting, from the plurality of digital event records, user-identity-related attributes;
constructing, for the plurality of online subscriber environments, a global identity graph, wherein generating the global identity graph comprises:
identifying, for each of the online subscriber environments, a respective plurality of digital accounts referenced within the plurality of digital event records for the online subscriber environment;
constructing a plurality of user account node data objects, wherein each user account node data object of the plurality is linked to a respective digital account identifier; and
constructing a plurality of edge objects representing direct digital threat associations within the plurality of user account node data objects, wherein each edge object corresponds to a match of one or more user-identity-related attributes between digital user accounts;
in response to constructing the global identity graph, automatically detecting indirect digital threat associations between given sets of node data objects of the plurality of user account node data objects by executing a multi-hop traversal instruction on the global identity graph;
storing the global identity graph and data associated with the direct and indirect digital threat associations in a queryable database of the digital fraud or digital abuse handling platform;
receiving, via a network by the digital fraud or digital abuse handling platform, a query related to a target digital user account of the plurality of digital user accounts;
using the query to access, from the queryable database, at least the data associated with digital threat associations for a target user account node data object corresponding to the target digital user account;
returning, by the digital fraud or digital abuse handling platform, a digital object based at least in part on completing the query, wherein the digital object is generated based at least in part on the accessed data associated with the digital threat associations for the target user account node data object.

2. The method according to claim 1, the method further comprising:
identifying a cluster of user account node data objects, wherein the cluster includes the target user account node data object and connected user account node data objects with which the target user account node data object has direct digital threat associations or indirect digital threat associations;
aggregating historical behavioral information associated with the target user account node data object and the connected user account node data objects to generate a threat profile for the target user account node data object; and
generating the digital object based at least in part on the threat profile.

3. The method according to claim 2, wherein:
the interface of the digital fraud or digital abuse handling platform comprises a graphical user interface; and
the digital object comprises a visualization artifact configured to display information associated with the generated threat profile when provided to the graphical user interface.

4. The method according to claim 3, wherein:
the visualization artifact is generated while withholding one or more underlying user-identity-related attributes used to construct the global identity graph, thereby enabling the information within the generated threat profile to be displayed at the graphical user interface without exposing the one or more underlying user-identity-related attributes.

5. The method according to claim 3, wherein the visualization artifact comprises:
a list of connected user account node visualization objects, wherein each entry within the list comprises:
an index corresponding to a respective connected user account node data object of the cluster,
an attribute-combination pattern used to identify the match between the target user account node data object and the respective connected user account node data object, and
one or more usage or transaction metrics associated with the respective connected user account node data object,
wherein:
the connected user account node visualization objects within the list are grouped according to subscriber-environment classifications associated with the respective connected user account node data objects.

6. The method according to claim 3, wherein the visualization artifact comprises:
a summary object indicating aggregated behavioral information associated with the connected user account node data objects within the cluster over a defined historical period.

7. The method according to claim 3, further comprising:
deriving a respective geographic region identifier for each of the connected user account node data objects that have direct digital threat associations or indirect digital threat associations with the target user account node data object;
adding, to the visualization artifact, a geographic visualization object that includes the geographic region identifiers while withholding one or more underlying user-identity-related attributes used to construct the global identity graph, thereby enabling the geographic visualization object to display the geographic identifiers at the graphical user interface without exposing the one or more underlying user-identity-related attributes.

8. The method according to claim 3, further comprising:
detecting, based at least in part on the threat profile, that the cluster corresponds to a fraud ring or an abuse ring;
adding, to the visualization artifact, an alert or visual indication indicative of coordinated fraud or abuse activity based at least in part on detecting that the cluster corresponds to a fraud ring or abuse ring.

9. The method according to claim 3, wherein the visualization artifact comprises:
a target user account node visualization object corresponding to the target user account node data object;
one or more connected user account node visualization objects, wherein each connected user account node visualization object corresponds to a respective connected user account data object that has a direct digital threat association or indirect digital threat association with the target user account node data object; and
one or more edge visualization objects, wherein each edge visualization object corresponds to a respective edge object linking the target user account node data object to a respective connected user account data object.

10. The method according to claim 3, wherein the visualization artifact comprises:
one or more selectable control elements that, when selected via user input, initiates execution of at least one workflow rule at the digital fraud or digital abuse handling platform, thereby modifying an operation of the target digital user account.

11. The method according to claim 2, the method further comprising:
generating, for each user account node data object within the global identity graph, a respective threat profile, wherein:
storing the data associated with the direct and indirect digital threat associations comprises storing the respective threat profile for each user account node data object within the queryable database, and
accessing the data associated with digital threat associations for the target user account node data object comprises accessing the threat profile for the target user account node data object from the queryable database.

12. The method according to claim 2, further comprising:
generating the threat profile for the target user account node data object based at least in part on the data accessed from the queryable database using the query associated with the digital threat associations for the target user account node data object.

13. The method according to claim 1, wherein the query includes one or more user-identity-related attribute values of the target digital user account, the method further comprising:
locating the target user account node data object within the global identity graph linked to the target digital user account based at least in part on the one or more user-identity-related attributes values included within the query; and
encoding, within the digital object prior to the outputting, identity information of the target user account node data objects and one or more connected user node data objects with which the target user account node data object has direct digital threat associations or indirect digital threat associations.

14. The method according to claim 1, wherein constructing an edge object of the plurality of edge objects comprises:
applying, to the extracted user-identity-related attributes, one or more configurable matching rules to determine that a match of the one or more user-identity-related attributes has occurred, wherein applying the one or more configurable matching rules comprises:
determining that the one or more user-identity-related attributes satisfy an attribute-combination pattern defined by the one or more configurable matching rules;
generating a confidence score based on one or more discriminative weights, each of the one or more discriminative weights corresponding to a respective attribute type of the one or more user-identity-related attributes; and
assigning the one or more user-identity-related attributes and the confidence score to the edge object.

15. The method according to claim 1, further comprising:
generating, for each user account node data object in the global identity graph, a respective threat indicator based at least in part on the direct digital threat associations and detected indirect digital threat associations linked to the associated digital user account;
determining that the target user account node data object has a quantity of associations with high-threat user account node data objects that exceeds a predefined association quantity threshold, wherein each of the high-threat user account node data objects have a threat indicator exceeding a predefined threat threshold;
adjusting the threat indicator to indicate a higher threat likelihood based at least in part on the quantity of digital threat associations with high-threat user account node data objects exceeding the predefined association quantity threshold.

16. The method according to claim 15, further comprising:
predicting, based on the adjusted threat indicator, whether the target digital user account satisfies at least one of:
a fraudulent activity condition associated with the target user account node data object;
an abuse activity condition associated with the target user account node data object; or
a predicted adverse authorization outcome associated with the target user account node data object.

17. A method for mitigating digital fraud or digital abuse within one or more online environments, comprising:
obtaining, from one or more distributed data sources, a plurality of digital event records associated with a plurality of online subscriber environments;
extracting, from the plurality of digital event records, user-identity-related attributes;
constructing, for the plurality of online subscriber environments, a global identity graph, wherein generating the global identity graph comprises:
identifying, for each of the online subscriber environments, a respective plurality of digital accounts referenced within the plurality of digital event records for the online subscriber environment;
constructing a plurality of user account node data objects, wherein each user account node data object of the plurality is linked to a respective digital account identifier; and
constructing a plurality of edge objects representing direct digital threat associations within the plurality of user account node data objects, wherein each edge object corresponds to a match of one or more user-identity-related attributes between digital user accounts;
in response to constructing the global identity graph, automatically detecting indirect digital threat associations between given sets of node data objects of the plurality of user account node data objects by executing a multi-hop traversal instruction on the global identity graph;
generating, for each user account node data object in the global identity graph, a respective threat indicator based at least in part on the direct digital threat associations and detected indirect digital threat associations linked to the associated digital user account; and
executing at least one workflow rule that modifies operation of a target digital user account associated with a target user account node data object, wherein the at least one workflow rule is executed based at least in part on the respective threat indicator and the respective digital threat associations corresponding to the target user account node data object.

18. The method according to claim 17, further comprising:
determining that the target user account node data object linked to the target digital user account has a quantity of digital threat associations with high-threat user account node data objects that exceeds a predefined association quantity threshold, wherein each of the high-threat user account node data objects have a threat indicator exceeding a predefined threat threshold, wherein:
executing the at least one workflow rule is based at least on the quantity of digital threat associations exceeding the predefined association quantity threshold; and
executing the at least one workflow rule comprises:
placing the target digital user account into a limited-functionality mode requiring one or more additional authentication factors;
blocking or placing a hold on one or more transactions associated with the target digital user account; or
routing the target digital user account to a fraud analyst interface for manual review.

19. The method according to claim 17, further comprising:
determining that the target digital user account associated has an age below a predefined threshold; and
determining that the target user account node data object linked to the target digital user account has a quantity of digital threat associations with low-threat user account node data objects that exceeds a predefined association quantity threshold, wherein each of the low-threat user account node data objects have a threat indicator below a predefined threat threshold, wherein:
executing the at least one workflow rule is based at least on the quantity of digital threat associations exceeding the predefined association quantity threshold when the age of the digital user account is below the age threshold; and
executing the at least one workflow rule comprises:
placing the target digital user account into a full-functionality mode with a same number of authentication factors as the low-threat digital user accounts; or
allowing one or more transactions associated with the target digital user account.

20. A computer-implemented system comprising:
processing circuitry;
a memory; and
a computer-readable medium operably coupled to the processing circuitry the computer-readable medium having computer-readable instructions stored thereon that, when executed by the processing circuitry, cause a computing device to perform operations comprising:
obtaining, from one or more distributed data sources, a plurality of digital event records associated with a plurality of online subscriber environments;
extracting, from the plurality of digital event records, user-identity-related attributes;
constructing, for the plurality of online subscriber environments, a global identity graph, wherein generating the global identity graph comprises:
identifying, for each of the online subscriber environments, a respective plurality of digital accounts referenced within the plurality of digital event records for the online subscriber environment;
constructing a plurality of user account node data objects, wherein each user account node data object of the plurality is linked to a respective digital account identifier; and
constructing a plurality of edge objects representing direct digital threat associations within the plurality of user account node data objects, wherein each edge object corresponds to a match of one or more user-identity-related attributes between digital user accounts;
in response to constructing the global identity graph, automatically detecting indirect digital threat associations between given sets of node data objects of the plurality of user account node data objects by executing a multi-hop traversal instruction on the global identity graph;
storing the global identity graph and data associated with the direct and indirect digital threat associations in a queryable database of the digital fraud or digital abuse handling platform;
receiving, via a network by the digital fraud or digital abuse handling platform, a query related to a target digital user account of the plurality of digital user accounts;
using the query to access, from the queryable database, at least the data associated with digital threat associations for a target user account node data object corresponding to the target digital user account;
returning, by the digital fraud or digital abuse handling platform, a digital object based at least in part on completing the query, wherein the digital object is generated based at least in part on the accessed data associated with the digital threat associations for the target user account node data object.
